(19) United States
(12) Patent Application Publication
(10) Pub. No.: US 2016/0166956 A1
(43) Pub. Date: Jun. 16, 2016

(54) SEPARATION OF MATERIALS

(71) Applicant: Z-Splitter Pty Ltd, Canning Vale (AU)

(72) Inventor: Neil Deryck Bray Graham, Canning Vale (AU)

(73) Assignee: Z-Splitter Pty Ltd, Canning Vale (AU)

(21) Appl. No.: 15/049,177

(22) Filed: Feb. 22, 2016

Related U.S. Application Data
(63) Continuation of application No. PCT/AU2014/000827, filed on Aug. 20, 2014.

(30) Foreign Application Priority Data
Aug. 20, 2013 (AU) 2013903149

(51) Int. Cl. B01D 33/03; B02C 23/18; B02C 23/08

(52) U.S. Cl. CPC B01D 33/03; B02C 23/08; B02C 23/18

(57) ABSTRACT

A separation system and method of separating solid particles of various sizes into oversize and undersize solids is described herein. The system includes a chamber for receiving feed material that includes a fluid containing solid particles of various sizes, and a flexible medium bounding the chamber and adapted to provide a selective barrier through which some solid particles can pass but not others. The system further includes a vibrator adapted to impart vibration to the flexible medium to facilitate passage of fluid and certain solid particles therethrough. The vibrator is further adapted to apply vibration to one or more discrete locations on an exterior face of the flexible medium with respect to the chamber, with the vibration causing the flexible medium to oscillate towards and away from fluid within the chamber.

### CROSS-REFERENCE TO RELATED APPLICATIONS

The present application claims the benefit under 35 U.S.C. §363, §365(c) and §120 of PCT International Application Serial No. PCT/AU2014/000827 to applicant Z-Splitter Pty. Ltd., filed Aug. 20, 2014, pending, which in turn claims priority to pending Australia Pat. Appl. Ser. No. 2013903149 to applicant, filed Aug. 20, 2013. The entire contents of each application is hereby incorporated by reference herein.

### BACKGROUND

1. Field

The example embodiments in general are directed to the separation of materials. In arrangement, the separation may involve solids-solids separation, such as separation of particulate materials into oversize solids and undersized solids. In another arrangement, the separation may involve solid-fluid separation; that is, separation of solids from fluids.

2. Related Art

The related art is intended only to facilitate an understanding of the example embodiments comprising the present invention. The discussion is not an acknowledgement or admission that any of the material referred to is or was part of the common general knowledge as at the priority date of the application.

The example embodiments of the present invention to be described hereafter are particularly applicable to separation of settle-able fine coal from clay and optionally also ash. Accordingly, the example embodiments will primarily be discussed in relation to such separation, although it should be understood that it has application to solids-fluid separation and other settle-able solids-solids separation involving separation of other particles in a fluidized environment according to size represented by oversize particles and undersized particles. By way of example only, and without limitation, the example embodiments may be applicable to separation of iron ore fines in clay or other host material, separation of fines within bauxite material, and separation of undersize and oversize particles in drilling mud for the purpose of re-conditioning the drilling mud.

Fine coal is often accompanied by finely distributed contaminant materials such as clay and generally also ash, as well as finely divided rock and mineral particles including sand, lime, feldspar and pyrites. With coal distributed amongst contaminant materials in this manner, there is a tendency for the coal and the contaminant materials to agglomerate. It is difficult to effectively recover fine coal particles and reject finely disbursed contaminant materials such as clay particles using current techniques, as coal and clay are similar in many physical and chemical characteristics. Accordingly, it is common to simply discard fine contaminated coal particles, typically by dumping them into tailing dams or tailing/waste mountains.

An existing method of filtration is disclosed in U.S. Pat. No. 3,870,640. This describes the filtration of liquids with high solid contents such as colloidal gels, lime and clay slurries, starch solutions, clay coatings and the like. The liquid to be filtered is passed radially inwards through a cylindrical filtration element. This method of filtration may be effective at reducing the build-up of agglomerated solids on the outer skin of the cylindrical filter element, but does not address the problem of physically separating the differently sized particles or different types of material within an agglomerated mass. Similarly, it does not place different sized materials or different types of materials into different target areas. It also does not generate a condition in the source liquid with high solid content to assist in the breaking up of agglomerated solids. As the fluid flows radially inwards, the fluid itself does not serve to assist in maintaining tension in the filtration element.

A further existing method of filtration is disclosed in US 2010/0219118 involving the separation of liquids laden with fibers or solids so that solids and liquids can be more easily separated and more efficient use of liquid in the filtration process can be employed. This describes including vertical motions to the vibration of a cylindrical filter screen to assist in the cleaning of the filter screen. It does not, however, address the problem of physically separating the differently sized particles or different types of material within an agglomerated mass. Similarly, it does not place different sized materials or different types of materials into different target areas. It also does not generate a condition in the source liquid to assist in the breaking up of agglomerated solids.

Yet a further existing method of filtration is disclosed in U.S. Pat. No. 6,712,981. This describes a radially inwards flow of fluid through a cylindrical filter element, and a brush and ultrasonic energy source to limit the accumulation of solids against the filter element. This does not disclose the breaking up of undersized and oversized particles so that oversized particles are separated and collected. It also does not generate a condition to extend a shock wave into the source liquid with high solid content to assist in the breaking up of agglomerated solids.

US 2003/0075489 discloses a device for separating liquid from a slurry of liquid and solid particles, particularly for treatment of waste water, as well as the dewatering of slurries and sludge. The device has a settling chamber having a solid particle outlet at the bottom end and a liquid outlet opening at the top. A filter means is located at the top of the settling chamber, spanning the liquid outlet opening. A slurry inlet is provided for introducing slurry into the settling chamber below the filtering means. The arrangement is such that introduction of slurry into the settling chamber urges liquid to flow upwardly through the filtering means and escape from the settling chamber through the outlet opening at the top. This provides for separation of the liquid from the solid particles, with the solid particles settling out in the in the settling chamber to be compacted at the bottom of the chamber for removal through the outlet. The settling chamber has walls which taper downwardly to the outlet and through which vibrations may be transmitted to the slurry therein for assisting in the separation of liquid and solid particles and also assisting in compaction of the solid particles at the bottom end of the settling chamber. However, it does not address the problem of physically separating the differently sized particles or different types of material within an agglomerated mass in the slurry. Further, it also does not generate a condition in the slurry to assist in the breaking up of agglomerated solids.

Yet a further existing method and apparatus for screening is disclosed in U.S. Pat. No. 7,556,154. In particular, this relates to removal of debris from drilling fluid (known as drilling mud), involving passing the fluid through a vibrating screen which is disposed to present an upwardly directed top face and a downwardly directed bottom face, with the fluid passing upwardly through the screen and debris not passing through the screen settling generally lower than the bottom face of the screen for subsequent retrieval. The vibration assists in removal of mud from the debris. Debris retained by the screen is dislodged by the vibration and settles below the screen for subsequent retrieval. However, it does not address the problem of physically separating the differently sized particles or different types of material within an agglomerated mass by breaking-up the clay. Specifically, it does not contribute to changing the phase of the drilling mud by the vibration breaking-up the mud itself to produce a low viscosity fluid that allows the solids to fall or settle away from the screen and allows the particles to fall away from the screen, taking advantage of gravity in a low viscosity fluid environment. Further, it also does not generate a condition in the drilling mud to assist in the breaking up of agglomerated solids.

It is against this background that the present invention has been developed. In particular, in certain applications, the example embodiments to be described hereafter seek to clean fine coal so that sufficient solid contaminant material has been removed to an extent desired (i.e., by a user or by legislation).

### SUMMARY

An example embodiment is directed to a separation system. The system includes a chamber for receiving feed material that includes a fluid containing solid particles of various sizes, and a flexible medium bounding the chamber and adapted to provide a selective barrier through which some solid particles can pass but not others. The system further includes a vibrator adapted to impart vibration to the flexible medium to facilitate passage of fluid and certain solid particles therethrough. The vibrator is further adapted to apply vibration to one or more discrete locations on an exterior face of the flexible medium with respect to the chamber, with the vibration causing the flexible medium to oscillate towards and away from fluid within the chamber.

Another example embodiment is directed to a method of separating solid particles of various sizes into oversize and undersize solids. In the method, a mixture including a fluid and solid particles is formed, and then introduced into a chamber bounded by a flexible medium that is adapted to provide a selective barrier through which permitted solid particles can pass but which other solid particles are stopped. The flexible medium is vibrated to facilitate passage of fluid and permitted particles through the flexible medium. The vibration is adapted for application to one or more discrete locations on an exterior face of the flexible medium with respect to the chamber. The vibration causes the flexible medium to oscillate towards and away from fluid within the chamber.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a partly sectioned perspective view of a separation system according to an example embodiment.

FIG. 2 is a schematic sectional side view of the arrangement shown in FIG. 1.

FIG. 3 is a fragmentary view of an internal portion of the separation system.

FIG. 4 is a view similar to FIG. 3 with the exception that the separation system is shown in operation.

FIG. 5 is a schematic perspective side view of a filtering membrane forming part of the separation system and a vibrator for imposing a vibrating effect on the membrane.

FIG. 6 is a schematic side view illustrating a separation process being performed by the filtering membrane.

FIG. 7 is schematic view illustrating a shock-wave formation generated in the filtering membrane by the vibrator.

FIG. 8 is a schematic view of a portion of the filtering membrane, illustrating fluid flow therethrough.

FIG. 9 is a view similar to FIG. 8, with the exception that solids are shown having accreted on the membrane to inhibit fluid flow therethrough.

FIG. 10 is a schematic view of the arrangement shown in FIG. 9, but with the exception of the vibrator being about to be applied to the filtering membrane.

FIG. 11 is a view similar to FIG. 10 with the exception that vibration is being applied to the filtering membrane in order to dislodge some of the accreted solids.

FIG. 12 is a view illustrating the filtering membrane after the clearing effect of the vibration.

FIG. 13 is a view similar to FIG. 12, illustrating fluid flow through the filtering membrane together with undersize solids, with retention of oversize solids.

FIG. 14 is a view similar to FIG. 13 but illustrating only retention of oversize solids.

FIG. 15 is a schematic perspective view of a separation system according to another example embodiment.

FIG. 16 is a schematic perspective view of a separation system according to another example embodiment.

FIG. 17 is a schematic view of a separation system according to another example embodiment.

FIG. 18 is a schematic view illustrating several separation systems according to the example embodiments for operation in series.

FIG. 19 is a view somewhat similar to the arrangement shown in FIG. 18 but with variations.

FIG. 20 illustrates a separation system having an apparatus defining a generally cylindrical chamber for receiving feed material under pressure.

FIG. 21 illustrates a separation system having an apparatus defining a chamber of a generally annular cross-section for receiving feed material under pressure, where the upper inclined wall section is formed of the flexible permeable material which defines the filtering membrane.

FIG. 22 illustrates a separation system having an apparatus defining a generally annular cross-section for receiving feed material under pressure, but where the lower inclined wall section is formed of the flexible permeable material which defines the filtering membrane.

FIG. 23 illustrates a separation system having an apparatus defining a chamber having a generally cubic configuration for receiving feed material under pressure.

FIG. 24 illustrates a separation system having an apparatus defining a chamber for receiving feed material under pressure, where the chamber has a generally cylindrical upper section and a lower section which tapers downwardly to a bottom end section of the chamber.

### DETAILED DESCRIPTION

As to be described in more detail hereafter, the example embodiments of the present invention relate to separation of materials. In one arrangement, the separation may involve solids-solids separation, such as separation of particulate materials into oversize solids and undersized solids. In another arrangement, the separation may involve solid-fluid separation; that is, separation of solids from fluids. Where the separation involves separation of solid particulates into oversized materials and undersized materials, the solid particulates may be in a fluid mixture that is subjected to solid-fluid separation, whereby the undersized solid particulates are separated from the fluid mixture and the oversized particulates are retained in the fluid mixture for later separation. Where the separation involves separation of solids from fluids, it is likely that the separation will not be complete; that is, the separated solids will likely be contaminated with some fluid, and the fluid from which the solids have been separated will likely contain some undersize solids.

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

Reference to positional descriptions, such as “upper”, “lower”, “top” and “bottom”, are to be taken in context of the embodiments depicted in the drawings, and are not to be taken as limiting the invention to the literal interpretation of the term but rather as would be understood by the skilled addressee.

Additionally, where the terms “system”, “device”, and “apparatus” are used in the context of the example embodiments, they are to be understood as including reference to any group of functionally related or interacting, interrelated, interdependent or associated components or elements that may be located in proximity to, separate from, integrated with, or discrete from, each other.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

An example embodiment according to the present invention, to be described hereafter in detail, is directed to a separation system. The system includes a chamber for receiving feed material comprising fluid containing solid particles of various sizes, and a flexible medium bounding the chamber, the flexible medium providing a selective barrier through which some solid particles can pass but not others. The system further includes a vibrator for vibrating the flexible medium to facilitate passage of fluid and certain solid particles through the flexible medium. The vibration causes the flexible medium to oscillate towards and away from fluid within the chamber.

Solid particles of a size which can pass through the barrier are hereinafter referred to as undersize solids and solid particles which cannot pass through the barrier are hereinafter referred to as oversize solids. Typically, the fluid forming part of the feed material is liquid. The fluid may, however, comprise a gaseous fluid, or a mixture of liquid and gaseous fluid. The flexible medium is supported in a generally taut condition when the fluid acts upon it. The fluid has the effect of exerting an outwards force on the flexible medium.

The vibration typically induces fracturing of agglomerated matter comprising the solid particles within the fluid, leading to fragmentation of the agglomerated matter into the oversize solids and the undersize solids. Typically, the oversize solids are relatively hard particles which are not further fragmented by the vibration, and the undersize solids may comprise the products of fragmentation of softer solids particles in response to the vibration. The vibration has the effect of introducing a frequency of vibration or a shock wave into the liquid surface at the interface with the flexible medium and across the flexible medium.

With this arrangement, the vibration is introduced into the feed material at a liquid boundary surface thereof. The liquid boundary surface is, in effect, at a liquid-air interface, the reason being that the liquid surface at the interface with the flexible medium is exposed to air through the permeable nature of the flexible medium providing the selective barrier. It is believed that this provides a very effective way of introducing vibration into the feed material and facilitates spreading of the vibration along the liquid boundary surface without the damping effect which would otherwise occur if vibration were to be delivered internally within the liquid environment.

In an example, the fluid exerts pressure within the chamber, with the pressure exerted by the fluid being used in generation of the vibration. Typically, the fluid pressure provides a rebounding force in response to an external force imposed upon the flexible medium by the vibrator. The fluid pressure may comprise the hydraulic head of the fluid. Additionally, the feed material may comprise slurry comprising the solid particles and a liquid. Typically, the liquid comprises water.

In an example, the flexible medium presents an interior face exposed to the chamber (and thereby fluid within the chamber) and an exterior face from which the separated fluid and particles discharge after passage through the flexible medium. Typically, the majority of material passing through the flexible medium comprises the separated fluid, with the separated fluid streaming outwardly through the flexible medium under pressure. In an example, the chamber has an outlet through which remnant material comprising the oversize solids can leave the chamber. In another example, the system is adapted to cause impedance to flow of fluid from the chamber through the outlet.

In one arrangement, the outlet may be configured to generate a fluid pressure head which provides the impedance to flow; for example, the outlet may be configured to include an ascending or elevated portion arranged to generate the fluid pressure head. In another arrangement, the system may be adapted to retard discharge of remnant material from the chamber, thereby leading to formation of a dense mass of the remnant material which obstructs flow from the chamber, thereby providing the impedance to flow.

In this latter arrangement, the obstructing dense mass of material does not entirely block the passage of remnant material from the chamber but rather has a retarding effect on passage of remnant material. This serves to increase the residence time of the feed material in the chamber and prevents the fluid in the feed material from flowing directly out of the chamber through the outlet. In this way, a body of fluid material is continuously established and retained in the chamber during operation of the separation system, with the body of fluid material developing the hydraulic head of the fluid for pressuring the feed material in the chamber. With this latter arrangement, there is a balance between feed material entering the chamber and feed material leaving the chamber, with the latter being a combination of undersize solids and fluid leaving the chamber through the flexible material, and oversize solids and retained fluid in the remnant material leaving through the outlet.

In an example, the outlet is provided at or adjacent a bottom end section of the chamber and is adapted to retard discharge of remnant material from the chamber, thereby leading to formation of the dense mass of the remnant material which obstructs the outlet. The outlet may be so adapted by provision of a valve to regulate the flow and thereby promote formation of the dense mass of the remnant material.

Typically, the dense mass of material constitutes a plug of material, with the plug continually developing and moving through the chamber, typically through the outlet. The vibration induced into the feed material within the chamber serves to fluidize the plug of material so that it can progressively flow through the outlet rather than becoming a total obstruction. In an example, the rate of delivery of feed material into the chamber is regulated according to the rate at which the plug moves continually through the outlet.

In an example, the vibrator is adapted to apply vibration to one or more discrete locations on the exterior face of the flexible medium. In other words, the vibrator does not apply vibration to the entirety of the exterior face, but rather only one or more portions thereof which represent localized areas of the exterior face constituting the discrete locations. While the vibrator does not apply vibration to the entirety of the exterior face, it is not necessarily the case that the entirety of the exterior face does not vibrate to some extent. Vibration may propagate through the flexible medium and be exhibited beyond the discrete locations, including for example the entirety of the exterior face. While the vibrator may apply vibration to only one discrete location, it is preferably that it be adapted to apply vibration to a plurality of discrete locations. Where the vibrator is adapted to apply to a plurality of discrete locations, the vibrator may comprise a plurality of vibration devices arranged to impose vibration to the discrete locations.

In an example, the plurality of discrete locations comprises discrete locations disposed at spaced intervals on the exterior face of the flexible medium. The discrete locations may comprise permanent locations or transitory locations. If the discrete locations comprise permanent locations, the vibration is applied to the same discrete locations throughout the separation process. If the discrete locations comprise transitory locations, the locations on the exterior face to which vibration is applied may vary during the separation process. The variation may be continuous or intermittent.

The vibrator may impose a vibratory force on the flexible medium at each discrete location in one vibration direction only, relying on other forces to impose a return motion to the flexible medium at the discrete location to thereby establish oscillatory vibration motion. In an embodiment of the invention, the vibrator imposes an inwardly directed force at each discrete location and the return force to complete the oscillatory motion is provided by fluid pressure exerted on the interior face of the flexible medium by fluid within the chamber. In an alternative arrangement, the vibrator may be adapted to impose both an inwardly directed force and an outwardly directed return force to complete the oscillatory motion.

The vibratory motion of the flexible medium assists in maintaining the operating performance of the selective barrier. In particular, the vibratory motion of the flexible medium appears to have the effect of disrupting accumulation of solid particles on the flexible medium, including in particular on the interior face of the flexible medium. This is beneficial as accumulated solids can have the effect of adversely affecting the performance of the barrier, ultimately developing into a cake which could otherwise blind the flexible medium to fluid flow.

Further, the vibratory motion of the flexible medium appears to have the effect of facilitating passage of undersize solids through the flexible medium to the exterior face thereof. Still further, the shock wave generated by the vibratory motion of the flexible medium appears to have the effect of propelling undersize solids which have passed through the flexible medium outwardly away from the exterior face. Still further, the vibratory motion of the flexible medium appears to have the effect of shaking fluid which has passed through the flexible medium from the exterior face. The vibratory motion may also generate shock waves which propagate within the fluid, as mentioned above. The shock waves may serve to fracture, or at least assist in fracturing, agglomerated relatively soft solid particles within the fluid in the chamber.

Vibration energy transferred to the fluid in the chamber may be imposed upon elutriated materials that are free floating in the fluid and not in direct contact with each other. In this way, the flow can be maintained through the chamber, flushing undersize solids out from between the particles. The undersize particles may be conveyed towards the barrier for subsequent passage therethrough. Further, the shock waves within the fluid may assist in driving undersize solids through the flexible medium. The vibratory motion may also generate wave formations which propagate within the flexible medium. The wave formations may establish an interference pattern which generates at least one standing wave within the flexible medium. The standing wave(s) may provide energy for propelling undersize solids through the flexible medium and outwardly of the exterior face thereof.

In an example, the vibration is steady. However, the vibration may be imposed in some other pattern, such as an intermittent pattern (for example, periodic bursts) or cyclic pattern of delivery. The vibration may be at any appropriate amplitude. It is believed that particularly effective amplitude is likely to be in the range of about 6 mm to 12 mm. It should, however, be understood that the effective amplitude may vary according to characteristics of the flexible material and characteristics of the material being subjected to the separation process.

The vibration may be at any appropriate frequency. It is believed that a particularly effective frequency is likely to be in the range of about 3,000 cycles per minute to 6,000 cycles per minute. In an embodiment, a frequency of about 5,000 cycles per minute has been used. These frequencies have been identified using a small scale test unit. It should, however, be understood that the effective frequency may vary according to characteristics of the flexible material and characteristics of the material being subjected to the separation process.

As mentioned, the aforementioned frequencies were identified using a small scale test unit. It is anticipated that a production unit may require lower frequencies in order to provide time for the return force to complete the oscillatory motion under the influence of pressure exerted on the interior face of the flexible medium by fluid within the chamber.

In an example, the flexible medium comprises a filtering membrane adapted to provide a barrier to oversize solids. Typically, the filtering membrane allows passage of fluid and undersize particles therethrough. The filtering membrane may be selected so as to have a pore size appropriate for the separation process intended; that is, a pore size appropriate to deliver to specified cut (separation regime) between the oversize and undersize solids.

The filtering membrane has sufficient structural integrity to withstand the vibratory loading imposed on it. The filtering membrane may be of laminated construction. By way of example, the laminated construction may comprise inner and outer layers, with the inner layer providing the necessary fine filtration to exclude the oversize solids, and the outer layer being of more robust construction to accommodate hoop tension and resist wear though contact by the vibrator.

The flexible medium may bound the chamber by defining at least a portion of a wall thereof. The flexible medium may, however, define the entirety of the wall. The flexible medium may define a perimeter of the chamber; that is, the flexible membrane may define a wall extending around the chamber to define the outer confines thereof.

The flexible membrane may be of cylindrical configuration. With this arrangement, the cylindrical flexible membrane may be adapted to be supported at its two ends, and thus thereby be suspended in position between the two ends. In this way, the flexible membrane is relatively free to float or waft in response to vibratory influences imposed upon it. With this arrangement, the chamber may be of cylindrical configuration.

The separation system may further comprise a delivery means for delivering feed material to the chamber. The delivery means may comprise a header tank from which feed material can gravity flow into the chamber. The separation system may further comprise a discharge means for removing remnant material from the chamber. The remnant material comprises solid particles which have not passed through the flexible medium. While in certain applications of the invention, almost all of the fluid would have discharged from the chamber through the flexible medium, the solid particles in the remnant material will likely be contaminated with some retained fluid. In such circumstances, the remnant material comprises the solid particles and the retained fluid. The remnant material may also comprise some trapped undersize solids. The remnant material may be subsequently subjected to a further separation process, or another process such as a drying process, to remove the retained fluid from the solid particles. The discharge means may comprise a fluid delivery system for promoting flow of the obstructing dense mass of material which establishes the plug.

In one arrangement, the fluid delivery system may be operable to fluidize the dense mass. With such an arrangement, the fluid delivery system may be arranged to elutriate the dense mass to flush any entrapped fines (undersize solids) in the dense mass back into the chamber while allowing oversize solids to flow from the chamber through the outlet. With this arrangement, the valve associated with the outlet to regulate the flow and thereby promote formation of the dense mass of the remnant material may serve to prevent the elutriated material from flowing directly out through the outlet and thereby losing the plugging effect. In another arrangement, the fluid delivery system may be operable to flush away the obstructing dense mass of material which establishes the plug. In another arrangement, the fluid delivery system may comprise a jet eductor.

The discharge means may comprise a conveyor for conveying the remnant material away. The conveyor may comprise a screw conveyor. Such an arrangement is particularly suitable in circumstances in which the obstructing dense mass of material which establishes the plug cannot flow from the outlet or cannot be removed by pumping or flushing. Other arrangements for the discharge means are possible, including a pumping piston arrangement, a paddle wheel arrangement, or a flexible discharge path to which vibration can be transmitted to propel the remnant material along and from the discharge path.

The separation system may further comprise means for delivery of replenishment fluid into the chamber. This is for the purpose of maintaining solid particles within the chamber in fluid suspension to accommodate fluid loss from the chamber. The fluid loss is predominately, if not entirely, through the flexible medium. In one example, the replenishment fluid may comprise fluid recycled from the feed material after having been discharged from the chamber through the flexible medium. In another example the replenishment fluid may comprise water. The water may be introduced directly into the chamber, or it may be introduced indirectly such as by being introduced into the feed material prior to the introduction of the latter into the chamber.

The replenishment fluid may be delivered as a flushing fluid into the chamber in a manner to assist in maintaining solid particles in suspension in the fluid within the chamber in an elutriated state. In this regard, the replenishment fluid is preferably injected into the chamber under pressure. In an example, the replenishment fluid is delivered into the chamber in a manner to establish one or more flow streams within the fluid to guide solid particles in suspension towards the flexible medium.

However, there need not be a requirement for replenishment fluid. In circumstances where there is a high proportion of fluid to solids in feed material, the fluid content may be sufficient for the separation process to be effected without the need for replenishment fluid.

The separation system may further comprise agitation means for agitating the fluid to assist in maintaining solid particles in suspension in the fluid within the chamber. The agitation means may comprise means for delivery of a gas such as air into the chamber. The agitation means may be arranged to bubble air into the fluid from a bottom region thereof. This may assist in elutriating solids within the fluid in the chamber.

The separation system may further comprise a means for promoting a longer residence time of feed material in the chamber. In one arrangement, the chamber may be configured to alter the flow of fluid within the chamber for the purpose of enhancing the residence time. By way of example, there may be elements disposed within the chamber for altering fluid flow to establish a meandering flow path and thereby enhance the residence time. The flow altering arrangement in the chamber may assist in establishing a guided flow of the fluid towards the interior face of the flexible medium.

In one arrangement, the flexible medium may present the interior face thereof in a generally upright disposition. This disposition is advantageous as it facilitates the flow of solids downwardly towards the bottom of the chamber. It may also accommodate a reverse flow arrangement in which there is fluid flow in an upward direction away from the bottom. In another arrangement, the flexible medium may present the interior face thereof in a sloping disposition. In the sloped disposition, the incline may be downwardly whereby the interior face is exposed to some of the oversize solids descending in the chamber. With this arrangement, descending oversize solids which encounter the sloping interior face can tumble or bounce along the interior face. This may be advantageous in assisting in scouring the interior face to remove accumulated solid particles.

In yet another arrangement, the flexible medium may present the interior face thereof in a generally horizontal disposition. With this arrangement, the flexible medium would likely be at the bottom of the chamber. The arrangement would, however, require some facility to transport or promote movement of oversize solids away from the flexible medium to enable clearing thereof.

In an example, the chamber is defined between an outer wall and an inner wall. The outer wall may comprise the flexible medium. The outer wall may be of tubular configuration. In this arrangement, the flexible medium may comprise a permanent tubular structure. In another arrangement, the flexible medium may comprise one or more panel sections having edged adapted to be joined together to form the tubular configuration. The outer wall may further comprise upper and lower sections between which the tubular flexible medium is sealingly connected.

The upper and lower sections, or at least one of the upper and lower sections, may be adapted to resiliently support the tubular flexible medium to facilitate vibratory movement thereof, and optionally also accommodate floating or wafting motion thereof in response to vibratory influences imposed upon it.

The inner wall may comprise a central structure. The central structure may be arranged to deliver the replenishment fluid. Further, the central structure may be adapted to accommodate infrastructure requirements, such as for example any service lines (such as fluid delivery lines) and any drive facility associated with a stirring or other fluid agitation mechanism at the bottom of the chamber. The inner wall may be formed so as to be shockwave absorbent or wave reflective so as to promote backwards reflection of an incident wave. The spacing between the outer and inner walls may be selected to limit the thickness of the body of fluid confined therebetween to a size which can be penetrated by shock waves generated by the vibrating flexible medium.

In one arrangement, the chamber may be configured so that the cross-sectional flow area thereof is substantially constant in the vertical direction. In another arrangement, the chamber may be configured so that the cross-sectional flow area thereof varies in the vertical direction. The variation may comprise a reduction in the cross sectional flow area in the downward direction. This may be advantageous as it reduces the volume available for fluid towards the bottom end of the chamber, thereby reducing the proportion of fluid within the oversize solids which have migrated to the bottom section of the chamber.

In an example, the separation system is configured such that the discharge means for removing remnant material from the chamber is disposed adjacent the bottom section of the chamber. With this arrangement, gravity is utilized to migrate the oversize solids to the discharge means. However, in another arrangement, the separation system may be configured such that the discharge means for removing remnant material from the chamber is disposed adjacent the top section of the chamber. In this arrangement, fluid flow may be used to convey oversize solids upwardly.

Typically, the separation process comprises an elutriation process for washing fine particles from the targeted material, with the fine particles being the undersize solids and the targeted material being the oversize solids.

The separation system according to the example embodiments described hereafter is applicable for cleaning fine coal to remove contaminant materials such as clay and generally also free ash, as well as finely divided rock and mineral particles including sand, feldspar and pyrites. In such an application the fine coal would constitute the oversize solids, and the contaminant materials, as well as ultra-fine coal, would constitute the undersize solids. In using the separation system for such a purpose, extracted material comprising fine coal, clay and ash (if any) is introduced into water to form a slurry which constitutes the feed material delivered to the separation system. In an example, the slurry is in a form which is pump-able.

Similarly, the example embodiments may be applicable to separation of iron ore fines in extracted material, with the iron ore fines constituting the oversize solids, and contaminant materials constituting the undersize solids. Again, in using the separation system for such a purpose, extracted material comprising the iron ores fines is introduced into water to form a slurry which constitutes the feed material delivered to the separation system, with the slurry preferably being pump-able.

As alluded to above, the separation system according to the example embodiments may have various other applications, including, but not limited to, separation of fines within bauxite material, and separation of undersize and oversize particles in drilling mud for the purpose of re-conditioning the drilling mud. In the application to drilling mud, the shock waves imparted directly to the highly thixotropic drilling mud that is designed to hold the cuttings in a supported locked environment for transportation away from the drill head (thus stopping the easy separation of the fines) may have the effect of fluidizing the drilling mud, breaking down the thixostrophy of the drilling mud and allowing it to flow like water, with the oversize solids simply falling out of the mud once it is fluidized. This phenomenon may also allow the drilling mud to more easily move through the screen as the screen is activated over its entire area by the shock waves travelling through it and the fluids which shears the thixotropic fluid/material and forces the fines from and through the screen. This radically lower viscosity and the high shearing means that the screen is highly unlikely to block, from either the thixostrophy of the mud or the blocking by the fines, or from those two factors working in combination whereby the fines settles inside the mesh and the clay plugs the holes.

Another example embodiment to be described hereafter is directed to a separation system which includes a chamber for receiving feed material comprising fluid containing solid particles of various sizes, and a flexible medium bounding the chamber, the flexible medium providing a selective barrier through which selected undersize solid particles can pass but not particles larger than the undersize solid particles. The system further includes a vibrator for vibrating the flexible medium to facilitate passage of fluid and solid particles through the flexible medium. The vibration causes the flexible medium to oscillate towards and away from fluid within the chamber.

Another example embodiment to be described hereafter is directed to a separation system that includes a chamber for receiving feed material comprising fluid containing solid particles of various sizes, and a flexible medium bounding the chamber, the flexible medium providing a selective barrier through which some solid particles can pass but not others. The system further includes a vibrator for vibrating the flexible medium to facilitate passage of fluid and solid particles through the flexible medium. The vibration causes the flexible medium to oscillate towards and away from fluid within the chamber, and a shockwave produced from the vibration of the flexible medium transfers into the feed material.

The shock wave transferring into the feed material may assist in facilitating the passage of some solid particles through the flexible medium, and may generate a standing wave within the feed material. The standing wave may have the effect of propelling solid particles through the selective barrier (being particles of a size which can pass though the barrier).

Another example embodiment to be described in detail hereafter is directed to a method of separating solid particles of various sizes into oversize and undersize solids. In the method, a mixture comprising a fluid and solid particles is formed and then introduced into a chamber bounded by a flexible medium providing a selective barrier through which permitted solid particles can pass but other solid particles do not pass. The flexible medium is subject to vibration to facilitate passage of fluid and permitted particles through the flexible medium. The vibration causes the flexible medium to oscillate towards and away from fluid within the chamber.

In an example, the vibration may not be continuous but rather is implemented on a selective basis. By way of example, the barrier may perform an effective separation process without vibration of the flexible medium until a stage at which it has been blinded by solids to an extent which inhibits effective separation. At or around that stage, or at another time deemed appropriate, vibration may be imposed upon the flexible medium to clear the blinded flexible medium and permit it to operate effectively.

Feed material comprising the mixture introduced into the chamber initially undergoes a separation process, with fluid and undersize solids passing through the barrier, and oversize solids being excluded from flow through the barrier. As the separation process continues, solids progressively accumulate on the barrier, thereby progressively restricting passage of undersize solids and fluid through the barrier. The retardation of fluid flow through the barrier leads to a backlog of feed material within the chamber which in turn develops a pressure head exerting fluid pressure on the flexible membrane. The fluid pressure may be used to impose a return motion to the flexible membrane in response to a vibratory force to establish oscillatory vibration motion.

In certain applications of the separation system according to the example embodiments, the material targeted by the separation process may comprise oversize solids constituting the remnant material or a component of the remnant material passing through the outlet. In certain other applications of the separation system according to the invention, the material targeted by the separation process may comprise the undersize solids passing through the flexible medium (the selective barrier). In certain other applications, both the undersize solids and the oversize solids may constitute target materials. In certain further applications, the liquid flowing through passing through the flexible medium (the selective barrier) may constitute a target material, either alone or in combination with one or more other target materials such as undersize and/or oversize solids.

The example embodiments described and illustrated hereafter relate to treatment of fine coal to clean the coal so that sufficient contaminant material has been removed to an extent desired for use as a combustion fuel. This is advantageous in raising the calorific value of the coal as a fuel. By way of example, the calorific value could be raised from about 4,000 kcal/kg to about 7,000-9,000 kcal/kg. In the case of metallurgical coal, the improvement in quality of the coal with the removal of contaminants may afford production of a better quality of steel and other products, and also a substantially higher market value for the coal.

The treatment involves separating solids material comprising fine coal particles and contaminant clay particles into oversize solids and undersize solids dependent upon the characteristics of the coal, with the targeted coal particles representing the oversize solids, and the containment clay particles (and other contaminants such as ash), as well as ultra-fine coal particles in certain circumstances, representing the undersize solids. In performing the separation, the solids material comprising fine coal particles and contaminant clay particles is formed into a slurry. The slurry comprises a liquid, which is typically water, and the solids material in a ratio appropriate to form slurry material which can be pumped for transportation.

The slurry comprises a feed material which is introduced into a chamber for exposure to a selective barrier through which undersize solids in the slurry, as well as liquid in the slurry, can pass but through which oversize solids cannot pass. The oversize solids which constitute the targeted fine coal particles are removed from the chamber. The targeted fine coal particles may be subjected to any further treatment as might be necessary to render them suitable for use, such as for example use as a combustion fuel or coking coal feed. The further treatment may, for example, involve gravity separation to isolate “heavies” (that is, the remaining ash from the lighter coal) and then also removal of the excess remnant moisture.

In the chamber, the solids material in the slurry typically separate under the influence of vibration into discrete particles to facilitate the separation process. In particular, those solid particles in the slurry which may have agglomerated with clay into larger masses are induced to separate from each other. The agglomerated larger masses may be prevailed upon by various effects to induce separation into the discrete particles, including generation of flow streams within the slurry, agitation of the slurry such as by injection of further water and/or a gas, generation of shock waves in the slurry, or any combination of these inducements, as well as other inducements. The undersize solids in the slurry, as well as liquid in the slurry, passing through the barrier discharge from the chamber.

Because liquid discharges from the chamber by passing through the barrier, the proportion of liquid to oversize solids retained within the chamber reduces. Typically, the oversize solids migrate towards the bottom section of the chamber from where they are ultimately removed. In this bottom section of the chamber the proportion of liquid to oversize solids retained within the chamber may be considerably lower than in sections of the chamber above it. This is advantageous as there is less liquid associated with the particular oversize solids which have migrated to the bottom section of the chamber.

Typically, replenishment flushing liquid is introduced into the chamber to compensate for some of the liquid lost through the barrier in order to maintain sufficient liquid for the solids material in the slurry to separate into discrete particles to maintain elutriation and facilitate the separation process performed by the barrier and the effects of vibration. The barrier is defined by a flexible medium which can be exposed to vibration, as will be explained in more detail later.

Typically, the flexible medium comprises a diaphragm adapted to perform a filtration process to allow passage of the undersize solids, as well as liquid in the slurry, through the barrier while not permitting passage of the oversize solids. The diaphragm may be in the form of a membrane. The membrane may provide at least part of a wall of the chamber, whereby undersize solids passing through the barrier, as well as liquid in the slurry passing through the barrier, discharge from the chamber. Typically, the liquid separated from the slurry feed material streams through the barrier under pressure and cascades down the outer side of the barrier.

The flexible medium is supported in a generally taut condition when the fluid acts upon it. The fluid has the effect of exerting an outwards force on the flexible medium. The flexible medium which provides the barrier is selected according to the requirements of the separation process and the characteristics of the slurry material, as would be well understood by a person skilled in the art. It is expected that viable separation can be achieved in a size range from about 2 mm down to about 5 micron, although separation outside of this range may also be possible.

The flexible membrane may, for example, comprise a filter fabric or a mesh screen. In one arrangement, where fine screening is required, such as for example down to 10-20 microns, the flexible medium may comprise a double layered laminate produced from PP or PET; for example, a double layered laminate comprising PET 33 filter fabric, with the two layers of fabric being hot welded together. In another arrangement, where there is a requirement for coarser screening such as for example up to 1-2 mm, the flexible membrane may comprise a stainless steel mesh of appropriate pore size. Further, the flexible medium may comprise a double layer of fine stainless steel mesh. The material selected for use as the flexible membrane would typically have appropriate rebound rates to respond as necessary to the imposed vibration and the return forces exerted by fluid pressure in the chamber.

Vibration is applied to the slurry feed material within the chamber, causing the flexible medium to vibrate, oscillating towards and away from the slurry within the chamber. The slurry feed material exerts fluid pressure within the chamber, with the pressure exerted by the fluid being used in generation of the vibration. Typically, the fluid pressure provides a rebounding force in response to an external force imposed upon the flexible medium to create the vibration. The fluid pressure may comprise the hydraulic head of the fluid.

The vibratory motion of the flexible medium assists in maintaining the operating performance of the system. In particular, the vibratory motion appears to have the effect of disrupting accumulation of solid particles on the flexible medium. This is beneficial as accumulated solids can have the effect of adversely affecting the performance of the barrier, ultimately developing into a cake which could otherwise blind the flexible medium against passage of the undersize solids, as well as liquid in the slurry. The vibratory motion also appears to have an effect of facilitating passage of undersize solids through the flexible medium to the exterior face thereof. Additionally, the vibratory motion appears to have an effect of propelling undersize solids which move through the flexible medium outwardly away from the barrier. Further, the vibratory motion appears to have the effect of shaking fluid which has passed through the flexible medium from the barrier.

The vibratory motion may also generate shock waves which propagate within the slurry in the chamber. The shock waves may serve to fracture, or at least assist in fracturing, agglomerated “soft” solid particles within the slurry. Further, the shock waves within the slurry may assist in driving undersize solids through the flexible medium. The vibratory motion may also generate wave formations which propagate within the flexible medium. The wave formations may establish an interference pattern which generates at least one standing wave within the slurry and/or on the flexible medium. The standing wave(s) may provide energy for propelling undersize solids through and beyond the flexible medium.

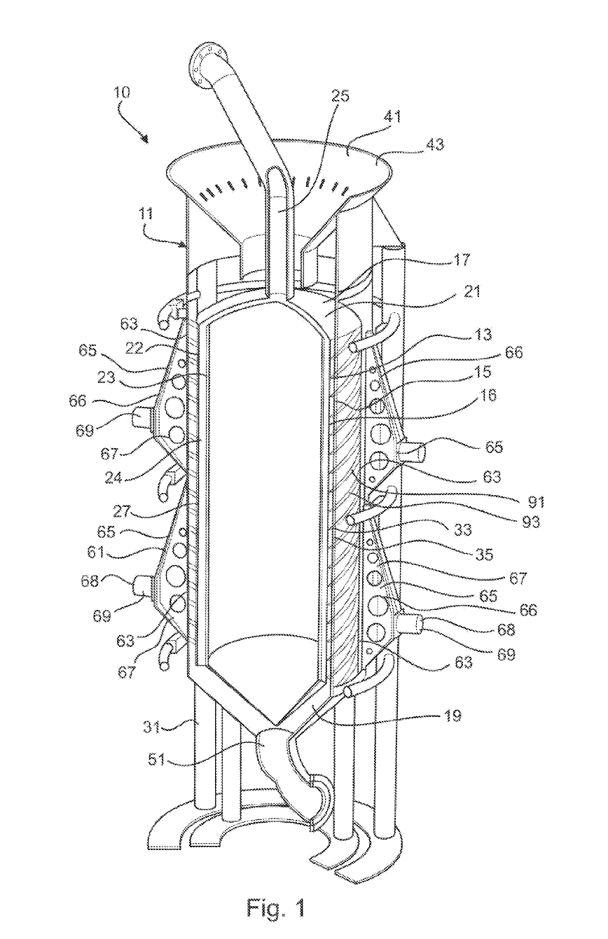

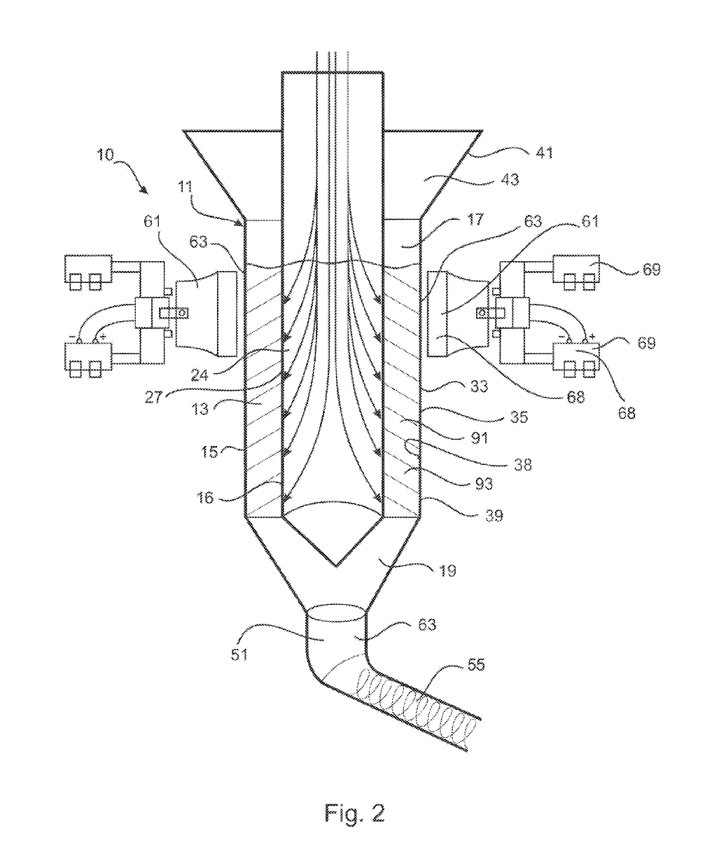

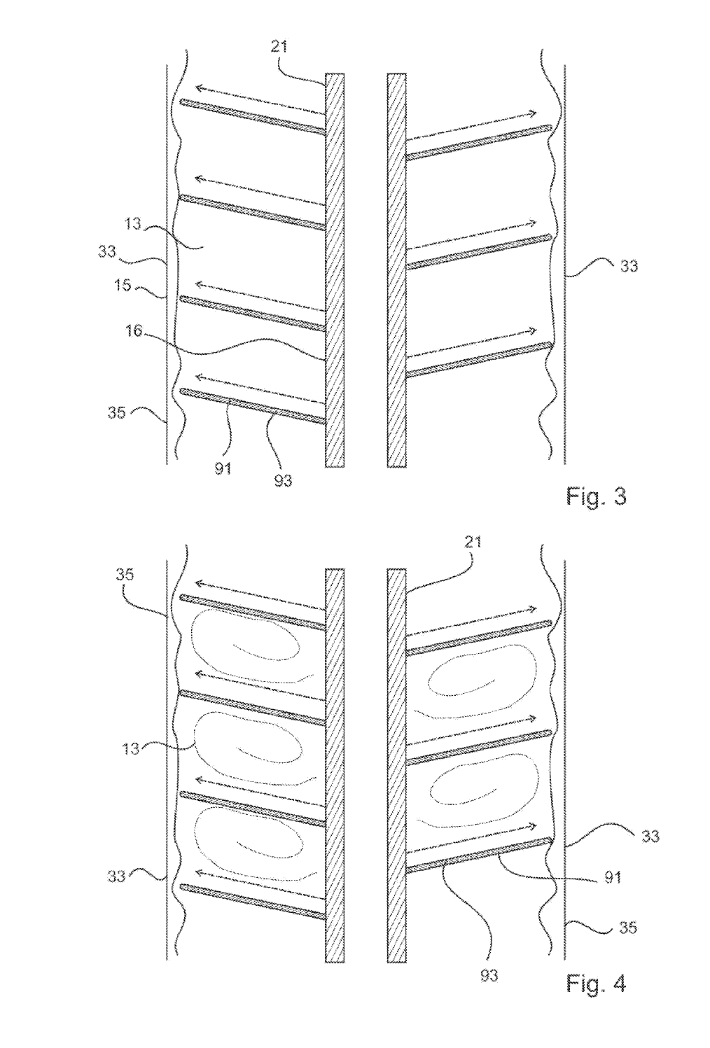

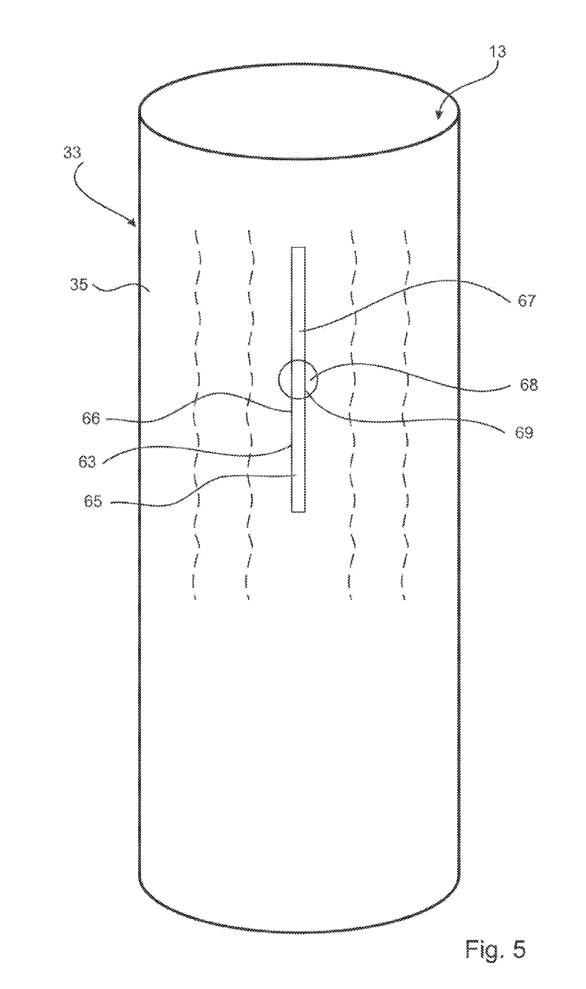

Referring now to FIGS. 1 to 14, an example embodiment of the separation system 10 is described. System 10 includes an apparatus 11 defining a chamber 13 for receiving feed material (being the slurry comprising fine coal particles and contaminants including clay particles and free ash). The chamber 13 includes an outer wall 15, a top end section 17 and a bottom end section 19 configured to incorporate an outlet through which remnant material (comprising oversize solids) can leave the chamber 13, as will be described in more detail later.

In the arrangement shown, the chamber 13 is of annular cross-section and so also has an inner wall 16, with the annular configuration being defined between the outer and inners walls 15, 16. Also in the arrangement shown, the outer and inners walls 15, 16 are of cylindrical configuration. While the system 10 shown includes the inner wall 16, such may not necessarily be required in other embodiments, particularly smaller versions of the system.

The inner wall 16 is defined by an internal structure 21. The internal structure 21 has an outer section 22 and an inner section 23 in spaced relation to define a cavity 24 to receive water through an inlet 25. The outer section 22 defines the inner wall 16 of the chamber 13 and is perforated or otherwise configured to facilitate flow of liquid (typically water) therethrough from the cavity 24 into the chamber 13. This provides a liquid replenishment means 27, the purpose of which will be described in more detail later.

The apparatus 11 includes a frame structure 31 which supports the top end section 17 and the bottom end section 19 of the chamber 13. The outer wall 15 of the chamber 13 includes a sleeve 33 extending between the top end section 17 and the bottom end section 19. The sleeve 33 is selectively removable and thereby adapted for releasable sealing connection at its ends to the top end section 17 and the bottom end section 19. Sleeve 33 may be formed from a flexible permeable material which defines a filtering membrane 35 providing a selective barrier through which undersize solids in the slurry, as well as liquid in the slurry, can pass but through which oversize solids cannot pass. The undersize solids comprise the contaminant material. The oversize solids, which constitute the targeted fine coal particles, are removed from the chamber in a manner which will be explained in more detail below. It is possible that not all undersize solids are sufficiently free to pass through the barrier, and some may be trapped within the chamber and become part of remnant material within the chamber.

The flexible permeable material which provides the filtering membrane 35 is selected so as to have a pore size appropriate to permit passage of particles of the undersize contaminant material, as well as liquid in the slurry, but not passage of the oversize-targeted fine coal particles. In the arrangement shown, the flexible permeable material which provides the filtering membrane 35 comprises pores 36 and strands 37 which bound and support the pores. In this embodiment, the filtering membrane 35 may be composed of a double layered laminate comprising PET 33 filter fabric, with the two layers of fabric being hot welded together. This filtering membrane 35 may be capable of separating clay and fine coal down to say 10-20 microns. This compares very favorably with traditional separation processes where separation below about 60 microns is not considered normally possible on a continuous basis and in sufficient volumes.

The filtering membrane 35 presents an interior face 38 exposed to the chamber 13 (and thereby slurry within the chamber) and an exterior face 39 from which the separated liquid and undersize contaminant particles discharge after passage through the filtering membrane. The filtering membrane 35 has sufficient structural strength to withstand vibratory loading imposed on it, as will be explained further later.

The separation system 10 includes a delivery means 41 for delivering feed material (the slurry material) in the top end section 17 of the chamber 13. The delivery means 41 is arranged to deliver the feed material into the chamber 13 under gravity flow. The delivery means 43 includes a header unit 43 which, in the arrangement shown, is configured as a hopper but may take any appropriate form.

The separation system 10 further includes a discharge means 51 for removing remnant material from the bottom end section 19 of the chamber 13. With this arrangement, the discharge means 51 constitutes the outlet. The remnant material comprises the targeted coal particles which have not passed through the barrier. Solid particles in the remnant material will likely be contaminated with some retained liquid (typically water). In such circumstances, the remnant material comprises the solid particles and the retained liquid. The solid particles in the remnant material may comprise not only coal particles but also other oversize solids, typically heavier than the coal particles. The remnant material may be subsequently subjected to a further separation process (generally gravity-based), or another process such as a drying process, to remove the retained liquid from the solid particles. The further separation process may separate the heavy solids from the lighter solid coal particles.

It is expected that viable separation can be achieved in a particle size range from about 2 mm down to about 5 micron. However, a 2 mm separation system will likely generate massive flows and require a feed delivery line of about 300 mm diameter in order to feed a chamber 13 of diameter of about 1500 mm and produce from about 50 to in excess of 175 tons of coal per hour, dependent upon the percentage of coal present in the feed material. From the 2 mm separation system, the output may be passed to multiple smaller separation systems. With this arrangement, a single large separation system may, for example, feed three 1 mm separation systems, which each 1 mm separation system in turn feeding five (5) 50 micron separation systems, which may in turn feed three (3) 20 micron separation systems. The foregoing is provided by way of example only, and it is to be understood that the separation system 10 is not limited to a size range from about 2 mm down to about 5 micron, nor to an arrangement requiring a multiple subsequent separation systems as descried.

In the arrangement shown, the discharge means 51 includes a gravity discharge section 53 communicating with a conveyor 55 for conveying the remnant material away. The conveyor 55 may in an example be embodied as a screw conveyor. A valve (not shown) may be associated with the conveyor 55 which is adapted to be opened in response to a condition requiring operation of the conveyor. Typically, the valve is forced open only when the conveyor 55 is fully loaded with solids. With this arrangement, the valve holds the material in the conveyor 55 until such time as a plug is formed. This ensures that oversize solids accumulate in the chamber 13 to inhibit flow to an extent required to optimize the performance of the system 10.

The separation system 10 further includes a vibrator 61 for selectively imparting vibration through the flexible filtering membrane 35 to the slurry feed material within the chamber 13, causing the filtering membrane 35 to vibrate, oscillating towards and away from the slurry within the chamber. The vibration facilitates passage of liquid and undersize contaminant particles through the filtering membrane 35. The vibrator 61 causes distortion of the filtering membrane 35, thereby impacting not only upon the filtering membrane but also the liquid surface presented by the slurry at the interface with the filtering membrane. The vibration has an effect of introducing a frequency of vibration or a shock wave into the liquid surface presented by the slurry at the interface with the filtering membrane 35 and across the filtering membrane.

The vibrator 61 is adapted to apply vibration to and through the flexible filtering membrane 35 at several discrete locations 63 at spaced intervals around the exterior face 39. In other words, the vibrator 61 does not apply vibration to the entirety of the exterior face 39, but rather at portions thereof which represent localized areas of the exterior face constituting the discrete locations 63.

While the vibrator 61 does not apply vibration to the entirety of the exterior face 39, it is not necessarily the case that the entirety of the exterior face 39 does not vibrate to some extent. Vibration would typically propagate through the flexible filtering membrane 35 and be exhibited beyond the discrete locations 63, including for example the entirety of the exterior face 39.

In this embodiment, the vibrator 61 includes a plurality of vibration sources 65 arranged so as to impose vibration to the one or more discrete locations 63. In the arrangement shown, each vibration source 65 includes a vibration device 66 having an elongate vibration head 67 adapted to confront the flexible filtering membrane 35 at the respective discrete location 63, and a vibratory drive 68 for delivering vibratory motion to the vibration head 67. The vibratory drive 68 includes one or more drive motors 69. The drive motors 69 may be powered in any appropriate way; for example, the drive motors 69 may be embodied as any of electric motors, hydraulic motors, or pneumatic motors to provide the impulse power in direct and oscillatory form.

The discrete locations 63 may include one or more permanent locations or transitory locations. If the discrete locations 63 include permanent locations, the vibration is applied to the same discrete locations 63 throughout the separation process. If the discrete locations 63 include transitory locations, the locations 63 on the exterior face 39 to which vibration is applied may vary during the separation process. The variation may be continuous or intermittent (for example, vibration may be imposed in bursts).

In this embodiment, each vibration device 66 imposes a vibratory force on the flexible filtering membrane 35 at the respective discrete location 63 in an inward vibration direction only, relying on other forces to impose a return motion to the flexible filtering membrane at the discrete location 63 to thereby establish oscillatory vibration motion. More particularly, each vibration device 66 imposes an inwardly directed force at the discrete location 63, and a return force to complete the oscillatory motion is provided by hydrostatic pressure exerted on the interior face 38 of the flexible filtering membrane 35 by slurry within the chamber 13. With this arrangement, there is no physical coupling between each vibration device 66 and the flexible filtering membrane 35 at the respective discrete location 63. The flexible filtering membrane 35 rebounds to present itself to each vibration device 66 under the influence of the return force imposed by hydrostatic pressure exerted on the interior face 38 of the flexible filtering membrane 35.

If the discrete locations 63 are embodied as transitory locations, the vibration sources 65 may move with respect to the sleeve 33. By way of example, the vibration sources 65 may move lengthwise along the sleeve 33, or may revolve around the sleeve, or may undergo a combination of such movements. In another arrangement, the sleeve may be caused to undergo motion with respect to the vibration sources 65.

The vibratory motion of the flexible filtering membrane 35 assists in maintaining the operating performance of the selective barrier provided by the flexible filtering membrane. In particular, the vibratory motion of the flexible filtering membrane 35 appears to have the effect of disrupting accumulation of solid particles on the interior face 38 and also on the strands 37 which bound the pores 36. This is beneficial as solid particles can accumulate through accretion on inner face 38 and on the strands 37, leading to development of a cake which could otherwise blind the flexible medium to fluid flow.

Further, the vibratory motion of the flexible filtering membrane 35 appears to have an effect of facilitating passage of undersize solids through pores 36 of the flexible filtering membrane 35 to the exterior face 39 thereof. Additionally, the vibratory motion of the flexible filtering membrane 35 appears to have an effect of propelling undersize solids which have passed through the pores 36 outwardly away from the exterior face 39. Still further, the vibratory motion of the flexible filtering membrane 35 appears to have the effect of shaking liquid from the surface of the flexible filtering membrane which has passed through the pores 36 to the exterior face 39.

The vibratory motion may also generate shock waves which propagate within the slurry in the chamber 13. The shock waves may serve to fracture, or at least assist in fracturing, agglomerated, “soft” solid particles within the slurry in the chamber 13. Further, the shock waves, combined with the generally outwardly directed flow from the chamber 13, may assist in driving undersize solids through the pores 36 of the flexible filtering membrane 35.

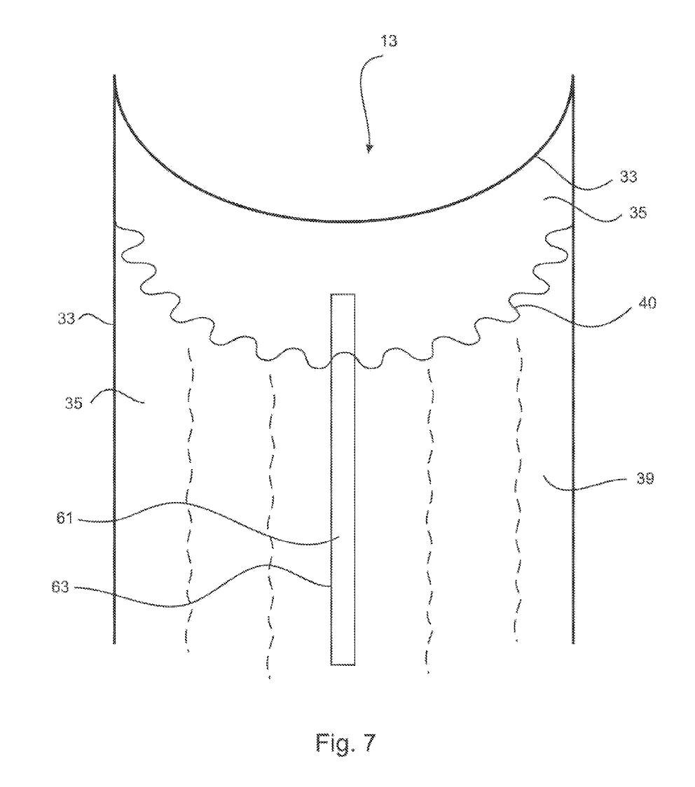

The vibratory motion may also generate wave formations which propagate within the flexible filtering membrane 35, as depicted schematically by line 40 in FIG. 7. The wave formations may establish an interference pattern which generates standing waves within the flexible filtering membrane 35. The standing waves may provide energy for propelling undersize solids through the pores 36 and outwardly of the exterior face 39. The vibration may be steady or it may be imposed in some other pattern, such as an intermittent pattern or cyclic pattern of delivery. Further, the vibration may vary in intensity; for example, the vibration may vary from no vibration or low intensity vibration to a high intensity vibration.

The vibration may be at any appropriate amplitude. It is believed that particularly effective amplitude is likely to be in the range of about 6 mm to 12 mm. It should, however, be understood that the effective amplitude may vary according to characteristics of the flexible material and characteristics of the material being subjected to the separation process. The objective is to attain a “sweet spot” that optimizes the energy input to the separated material output. Advantageously, the fluid pressure head established to maintain the flexible filtering membrane 35 in a taut condition and to also rebound the flexible filtering membrane to present itself to each vibration device 66 is balanced with the input energy imposed by the vibration devices 66, as well as the filtering characteristics of the flexible filtering membrane (such as the cut size determining oversize and undersize solids). It is expected that the “sweet spot” is likely to vary according to various parameters, including the material being separated, hydrostatic pressure in the chamber and the vibration rate. Higher hydrostatic pressures in the chamber 13 are likely to drive the slurry through more quickly, but require higher energy inputs to the vibration devices 66. Furthermore, the separation system 10 may stall if the hydrostatic pressure is too high or the slurry feed material is too dense.

The vibration may be at any appropriate frequency. It is believed that a particularly effective frequency is likely to be in the range of about 3,000 cycles per minute to 6,000 cycles per minute. In this embodiment, a frequency of about 5,000 cycles per minute has been used. These frequencies have been identified using a small scale test unit.

However, the effective frequency may vary according to characteristics of the flexible filtering membrane 35 and to characteristics of the slurry feed material being subjected to the separation process, including in particular the liquid component thereof. As mentioned, the aforementioned frequencies were identified using a small scale test unit. It is anticipated that a production unit may require lower frequencies in order to provide time for the return force to complete the oscillatory motion under the influence of fluid pressure exerted on the interior face of the flexible filtering membrane by fluid within the chamber.

The effect of the vibration is shown schematically in FIGS. 8 to 14. FIG. 8 shows the flexible filtering membrane 35 in operation, allowing passage of liquid and undersize contaminant particles through the pores 36, as depicted by flow lines identified by reference numeral 71. FIG. 8 also shows some accumulation of solid particles through accretion on the inner face 38 and on the strands 37 of the flexible filtering membrane 35, but not to an extent to adversely affect flow. The accumulation of solid particles will hereinafter be referred to as accretions identified by reference numeral 73. At this stage, it is not necessary to impose vibration on the flexible filtering membrane 35 to maintain its operating performance as a selective barrier.

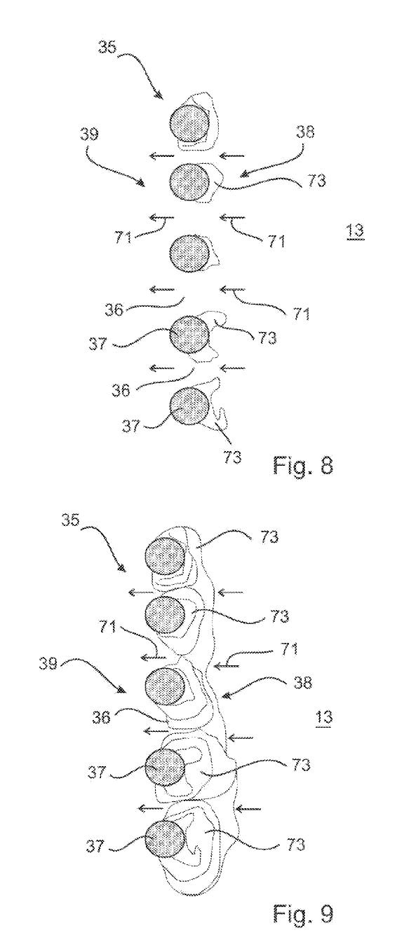

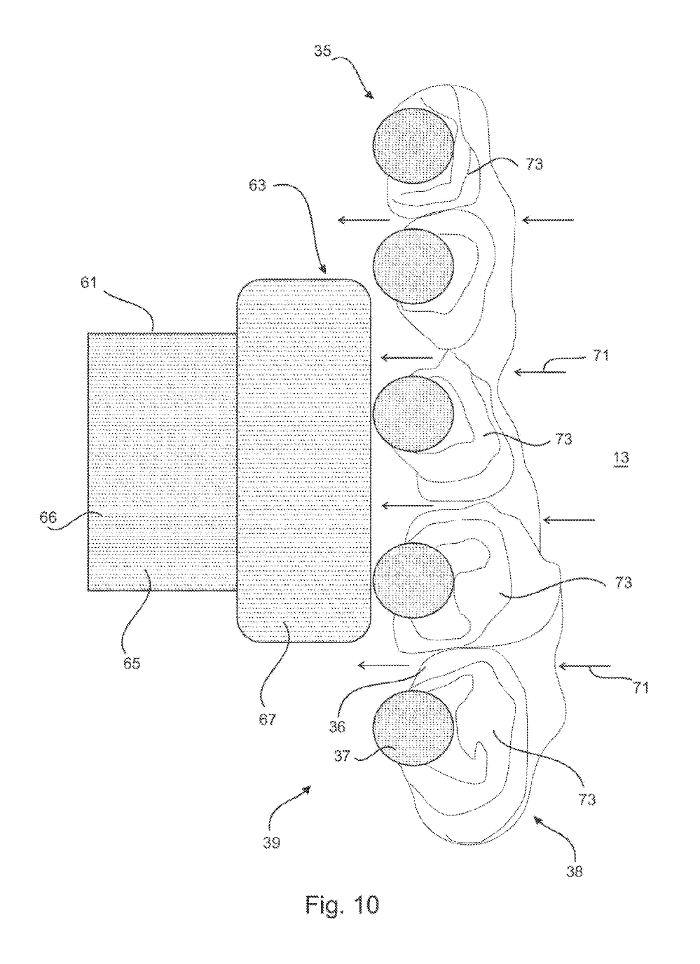

FIG. 9 is a view similar to FIG. 8, showing what would happen if the accretions 73 on the inner face 38 and on the strands 37 were allowed to continue. The pores 36 would progressively clog and flow through the flexible filtering membrane 35 would be progressively impeded, ultimately leading to development into a solids cake which could blind the flexible filtering membrane 35. FIG. 10 depicts presentation of one of the vibration heads 67 to a location 63 on the flexible filtering membrane 35.

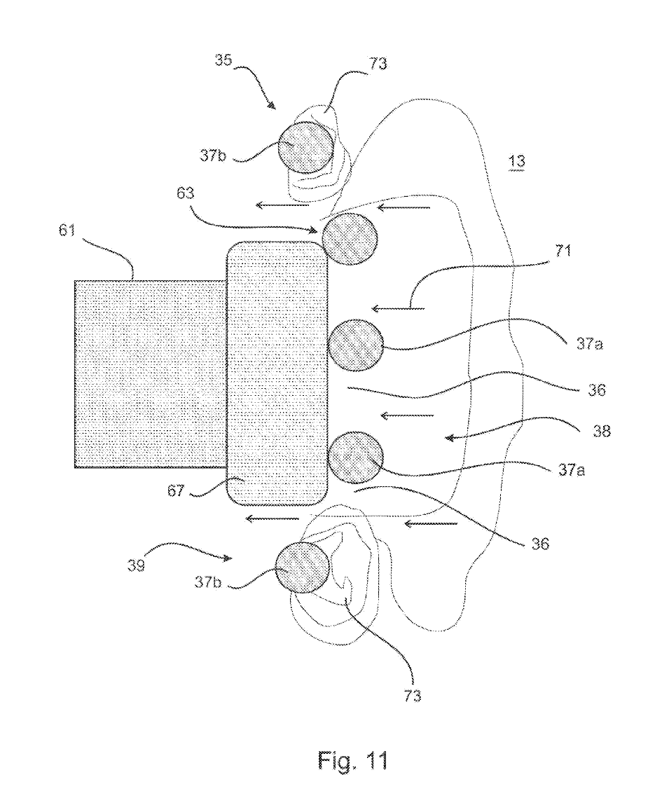

FIG. 11 depicts the effect of the imposition of vibration to the flexible filtering membrane 35 at the specific location 63 shown in FIG. 10. The vibration flexes and distorts the flexible membrane 35, as can be seen in FIG. 11 by the relative positions of strands 37a and 37b, the formers having been pushed inwardly relative to the latter by the vibration impact. The accretions 73 on the interior face 38 and also on the strands 37 which bound the pores 36 are disrupted (as they are essentially deposits of soft materials), clearing the pores 36 and allowing passage of the undersize contaminant solids, as well as liquid in the slurry, through the barrier.

More particularly, the impact of the vibration head 67 on the flexible filtering membrane 35 shears and shatters the accretions 73 around the strands 37. A shockwave of liquid and air is sent out from the impact point, progressing into and around the flexible filtering membrane 35 and shattering/shearing further soft accretions. The shock waves continue around the flexible filtering membrane 35 and around the liquid surface presented by the slurry at the interface with the filtering membrane 35. The shock waves induce shearing and shattering of the accretions over a large area, not just at the immediate impact point; this allows a massive increase in liquid flow through the barrier.

As the vibrator head 67 undergoes an outward stroke away from the chamber 13, the flexible filtering membrane 35 bounces outwards driven by the internal hydrostatic pressure within the chamber 13. In this way the tension on the strands 37 is not effected by any stretch of the strands. Consequently, any stretch in the strands 37 over time does not affect the ability of the flexible membrane to undergo the oscillatory motion.

The massive flow of liquid washes out the small particles and the shattered remains of the accretions almost immediately. The shockwaves in moving through the slurry may break up other weakened particles such as clay as they impact one particle against the other. These softer now broken undersize solids are then expelled from the chamber through the barrier with the liquid flow. Additionally, the oscillating strands 37 of the flexible filtering membrane 35 may come in contact with the soft particles and as they move rapidly backwards and forwards with the impact they fracture the particles and break them up into smaller particles that are washed out with the liquid flow.

However the oversize-targeted coal particles which are larger and harder are not easily broken and remain trapped inside the chamber 13. Larger coal particles may impact against the interior face 38 of the flexible filtering membrane 35 and be accelerated through the slurry. Additionally or alternatively, the shock waves generated from the vibration may move through the slurry, driving the larger coal particles in front of the wave. In this way the larger coal particles are separated from the smaller coal particles (being nevertheless still oversize solids). Furthermore, any mass of agglomerated softer particles in the slurry are fragmented and separated from harder particles in the slurry.

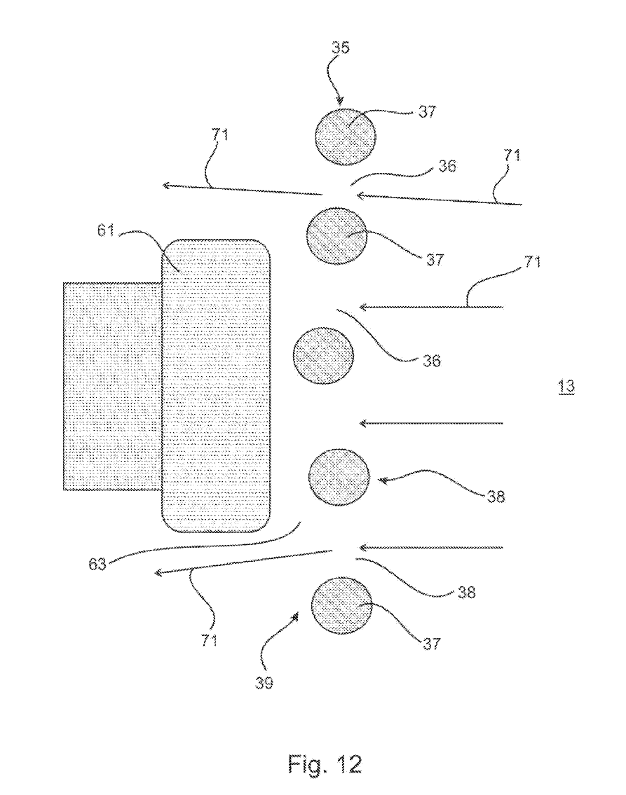

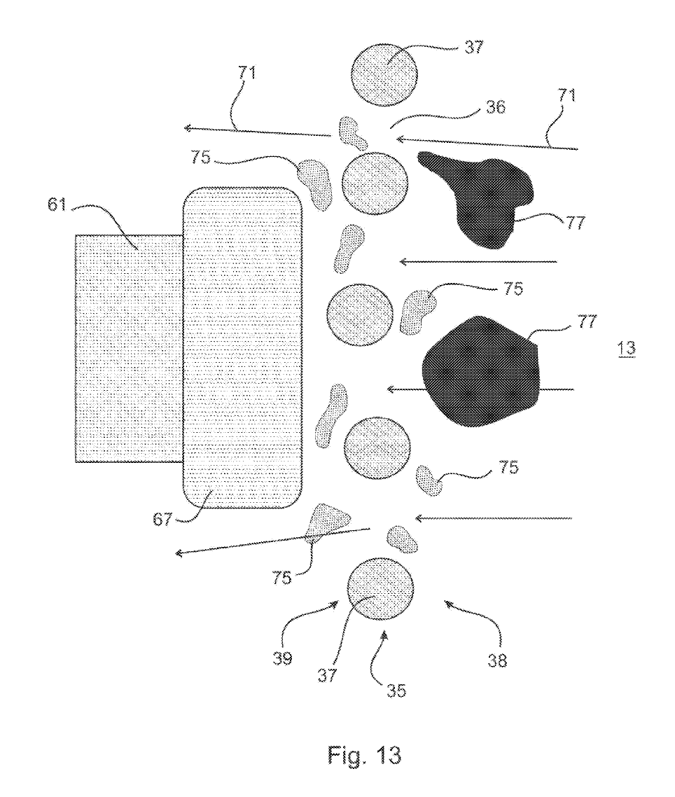

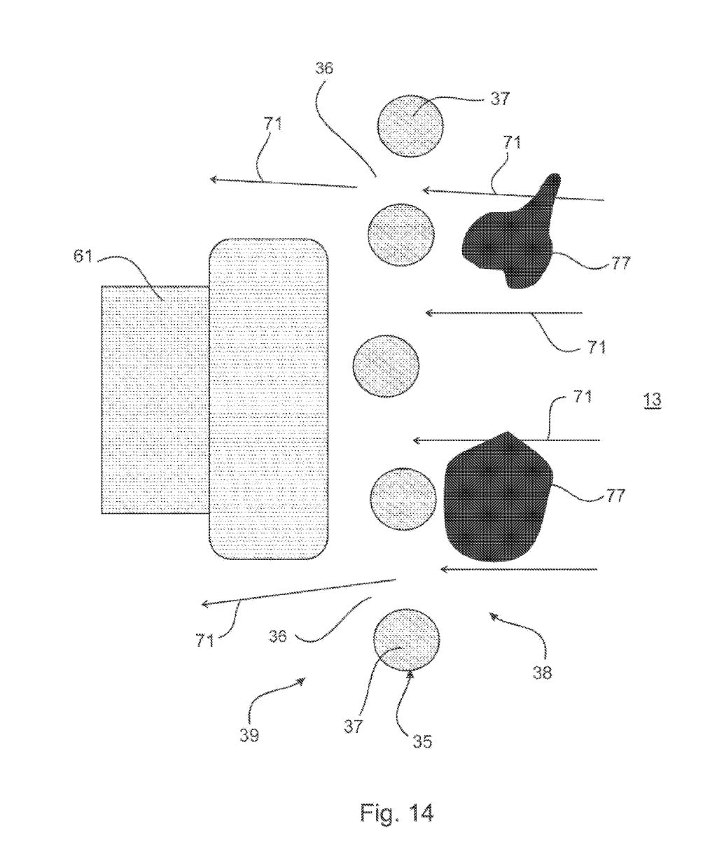

FIG. 12 shows the flow arrangement once the pores 36 have been cleared. FIG. 13 is similar to FIG. 12, depicting the cleared pores 36 allowing passage of the undersize contaminant solids, as well as liquid in the slurry, through the barrier while retaining the oversize-targeted coal particles. In the arrangement shown, the undersize contaminant solids are identified by reference numeral 75 and the retained oversize-targeted coal particles are identified by reference numeral 77. FIG. 14 is similar to FIG. 13, except that it depicts the condition in which all undersize contaminant solids have been removed and only liquid in the slurry flows through the barrier, while the oversize-targeted coal particles 77 are still retained by the barrier.

The separation system 10 is provided with the liquid replenishment means 27 for delivery of replenishment liquid (water) into the chamber 13. This is for the purpose of maintaining solid particles within the chamber in fluid suspension to accommodate liquid loss from the chamber 13. The fluid loss is predominately, if not entirely, through the flexible filtering membrane 35. However, there need not be a requirement for replenishment liquid. In circumstances where there is a high proportion of liquid to solids in feed material, the liquid content may be sufficient for the separation process to be effected without the need for replenishment liquid. In other words, there may be sufficient liquid for fluidization of the solid particles and to maintain the slurry elutriated and the solid particles free to move within the liquid in concert with the vibration.

The replenishment liquid may comprise liquid recycled from the feed material after having been discharged from the chamber 13 through the flexible filtering membrane 35.

The replenishment liquid is delivered into the chamber 13 from the cavity 24 within the internal structure 21 in a manner to assist in maintaining solid particles in suspension in the slurry within the chamber 13. In this regard, the replenishment liquid is preferably injected into the chamber 13 under pressure. More particularly, the replenishment liquid is delivered into the chamber 13 in a manner to establish one or more flow streams within the slurry to guide solid particles in suspension towards the interior face 38 of the flexible filtering membrane 35.

The separation system 10 further comprises agitation means (not shown) for agitating the slurry to assist in maintaining solid particles in suspension within the slurry within the chamber 13. The agitation means may comprise means for delivery of a gas such as air into the chamber. The agitation means may be arranged to bubble the gas into the fluid from a bottom region thereof. The gas (which is typically air) may be used to displace liquid (typically water) from the interstices between solid particles accumulating at the bottom end section 19 of the chamber 13 and thereby enhance formation of the dense mass of material which constitutes the plug. Furthermore, the displacement of the liquid may enhance drying of the accumulated dense mass of material which constitutes the plug of material continually developing and moving through the chamber 13, typically through the outlet provided by the discharge means 51.

The separation system 10 is configured to promote a longer residence time of slurry material in the chamber 13. For this purpose, the chamber 13 is configured to alter the flow of slurry within the chamber for the purpose of enhancing the residence time. In this embodiment, a flow guide arrangement 91 is disposed within the chamber 13 for altering fluid flow to establish a meandering flow path and thereby enhance the residence time. In the arrangement shown, the flow guide arrangement 91 serves to guide or otherwise promote flow towards the interior face 38 of the flexible filtering membrane 35. More particularly, in the arrangement shown, the flow guide arrangement 91 comprises a spiraling fin 93 within the chamber 13.

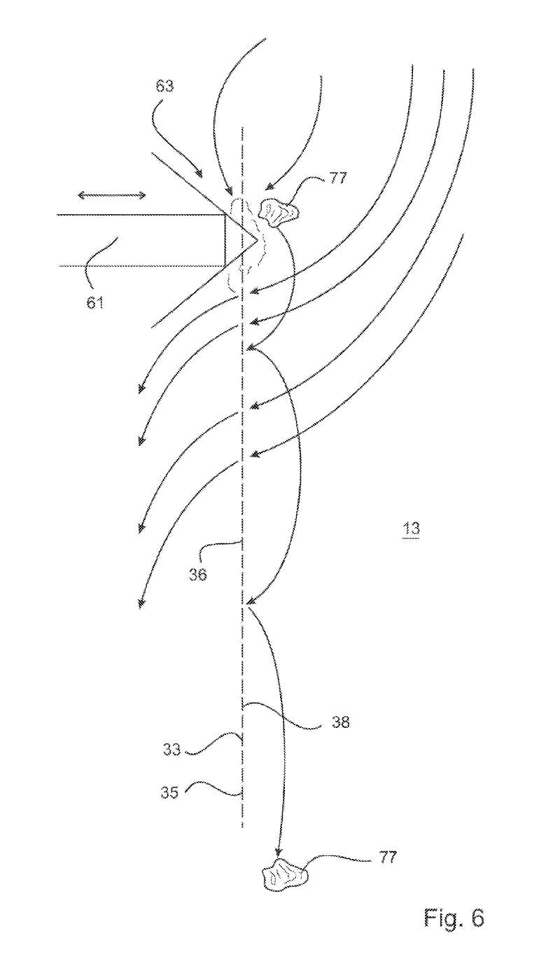

The oversize-targeted fine coal particles which are directed towards the interior face 38 of the flexible filtering membrane 35 descend under the influence of gravity, with at least some of the coal particles tumbling down the interior face, as depicted in FIG. 6. These particles are subjected to counteracting influences, one being an influence guiding the particles towards the interior face 38 and the other being vibration imposed on the flexible filtering membrane 35 having the effect of driving the particles away from the interior face 38. These counteracting influences have the effect of causing the oversize-targeted fine coal particles to tumble down the interior face 38, as explained and as depicted in FIG. 6. This may be advantageous in assisting in scouring the interior face 38 to remove accretions thereon.

Gravity is utilized to migrate the oversize-targeted fine coal particles to the discharge means 51 at the bottom of the chamber 13. During migration of the oversize-targeted fine coal particles to the bottom of the chamber 13, liquid is continuously discharging from the chamber 13 through the flexible filtering membrane 35. Replenishment liquid is delivered to the chamber 13 as previously explained, but to sections of the chamber 13 above the bottom end section 19.

Because liquid discharges from the chamber 13 through the flexible filtering membrane 35, the proportion of liquid to oversize-targeted fine coal particles retained within the chamber 13 reduces. In the bottom end section 19 of the chamber 13, the proportion of liquid to oversize-targeted fine coal particles retained within the chamber 13 is considerably lower than in sections of the chamber above it. This is advantageous as there is less liquid associated with the particular oversize-targeted fine coal particles which have migrate to the bottom end section 19 of the chamber 13. The reduction in liquid associated with the particular oversize-targeted fine coal particles can facilitate easier recovery of the fine coal particles from the chamber 13 and subsequent handling of those fine coal particles.

Typically, most, if not almost all, of the liquid would have been removed from the oversize-targeted fine coal particles accumulating in the bottom end section 19 of the chamber 13. Upon recovery from the chamber 13, the oversize-targeted fine coal particles may be subsequently subjected to a further separation process, or another process such as a drying process to remove any retained fluid from the solid particles.

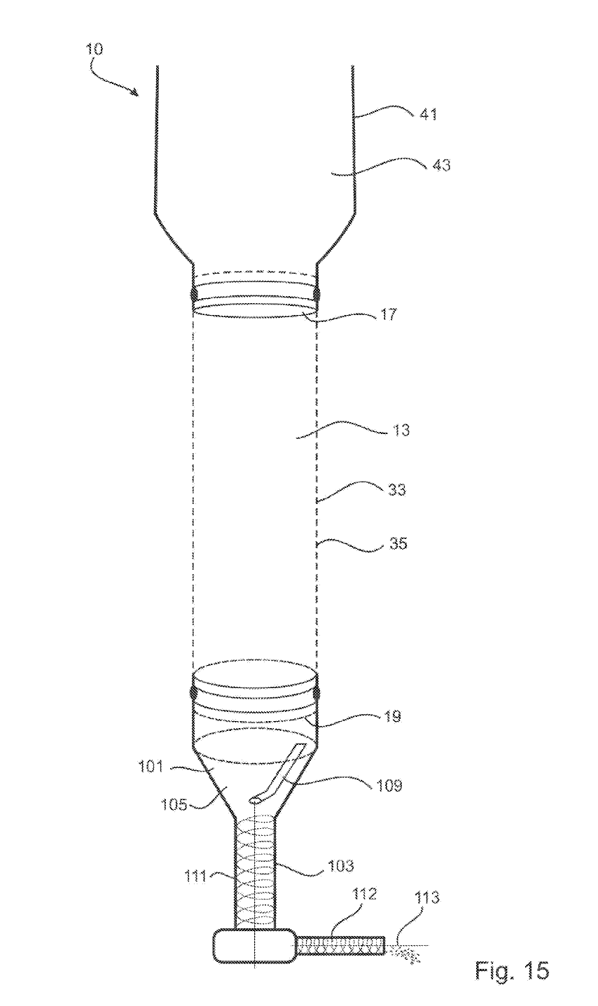

Referring now to FIG. 15, there is shown a separation system 10 according to another example embodiment. This embodiment is similar in many respects to the previous example embodiment and corresponding reference numerals are used to denote corresponding parts. Here, the bottom end section 19 of the chamber 13 opens onto a feed section 101 configured to receive remnant material from the chamber 13 and deliver it in compacted form to a conveyor 103 for conveying the remnant material away. The compacted form of the remnant material received from the chamber 13 effectively forms a plug 105 which serves to close or seal the bottom of the chamber 13 and thereby inhibit slurry within the chamber from flowing out through the bottom end section 19 of the chamber. This plug 105 is formed, or enhanced, by the valve associated with the conveyor, the arrangement being that the valve blocks flow until caused to open by the force exerted on it by the plug once it is fully developed. The presence of the plug controls or inhibits discharge of remnant material, thereby increasing residence time within the chamber 13 with the result that the separation process is rendered more effective.

The feed section 101 is configured as a hopper 107 for guiding the incoming remnant material received from the chamber 13 into a compacted mass which constitutes the plug 105. The feed section 101 includes means 109 for progressively moving the compacted mass which constitutes the plug 105 towards the conveyor 103. In the arrangement shown, the means 109 comprises a scraper adapter to move around the boundary wall of the hopper 107.

The conveyor 103 includes a first conveyor section 111 and a second conveyor section 112, each comprising a screw conveyor. The first conveyor section 111 communicates with the feed section 101 to receive material therefrom. The screw conveyor of the first conveyor section 111 is operatively coupled to the scraper 109 whereby rotation of the screw conveyor causes movement of the scraper around the boundary wall of the hopper 107.

The second conveyor section 112 receives material from the first conveyor section 111 carries it laterally to a discharge zone 113. In another arrangement, the conveyor 103 may comprise a screw conveyor communicating directly with the feed section 101 to receive material therefrom. With this arrangement, there is a single conveyor only.

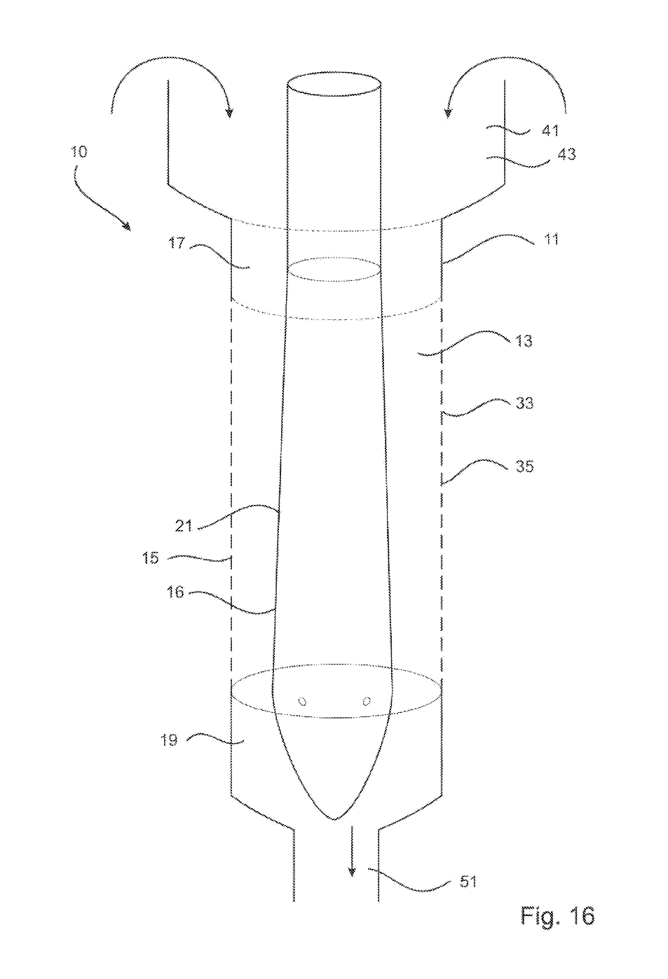

Referring now to FIG. 16, there is shown a separation system 10 according to another example embodiment, which is similar in many respects to previous embodiments; thus corresponding reference numerals are used to denote corresponding parts. In the first described embodiment, the chamber 13 was configured so that the cross-sectional flow area thereof is substantially constant in the vertical direction. The arrangement here is different. More particularly, here the chamber 13 is configured so that the cross-sectional flow area of the chamber 13 varies in the vertical direction. The variation includes a reduction in the cross-sectional flow area in the downward direction. This may be advantageous as it reduces the volume available for liquid towards the bottom end section 19 of the chamber 13, thereby reducing the proportion of liquid (water) within the oversize-targeted fine coal particles which have migrated to the bottom end section of the chamber. In the arrangement shown, the variation is achieved by tapering the inner wall 16 of the chamber 13 outwardly towards the outer wall 15 in the downward direction. The outlet may be configured to generate a fluid pressure head which provides the impedance to flow; for example, by configuring the outlet to include an ascending or elevated portion arranged to generate the fluid pressure head.

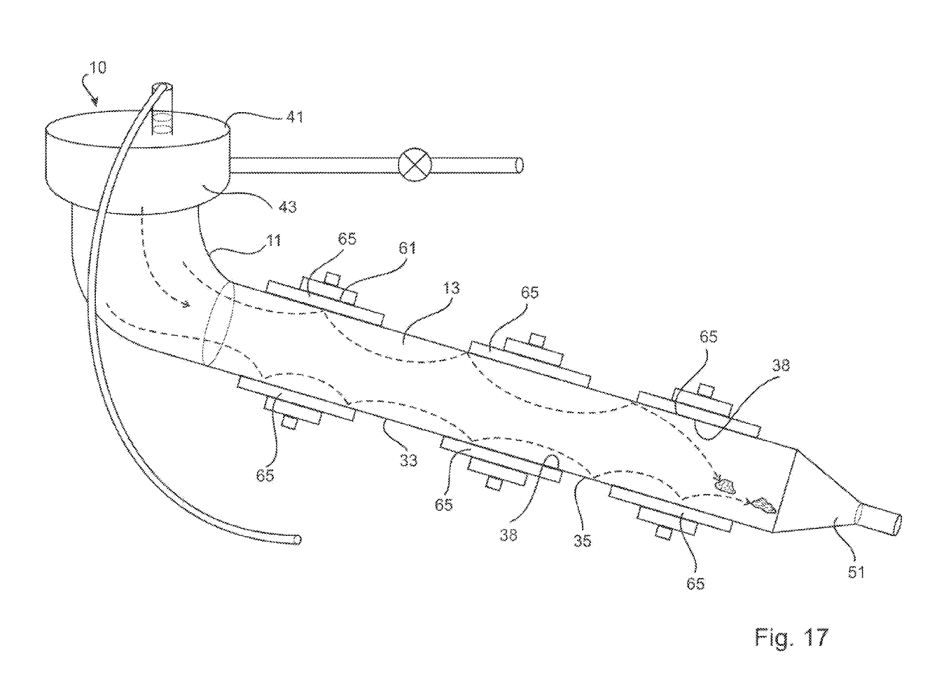

Referring now to FIG. 17, there is shown a separation system 10 according to another example embodiment which is similar in many respects to previous embodiments; thus corresponding reference numerals are used to denote corresponding parts. In the first described embodiment, the chamber 13 is configured so that the flexible filtering membrane 35 presents the interior face 38 in a generally upright disposition. The arrangement here is different.

More particularly, in this example embodiment, the chamber 13 is configured so that the flexible filtering membrane 35 presents the interior face 38 in a sloping disposition. With this arrangement, descending oversize solids which encounter the sloping interior face can tumble or bounce along the interior face 38. This may be advantageous in assisting in scouring the interior face to remove accumulated solid particles.

The separation systems 10 heretofore described may be arranged to operate individually, or in combination with one or more separation systems. These other separation systems may be configured in accordance with the example embodiments, or may be different systems.

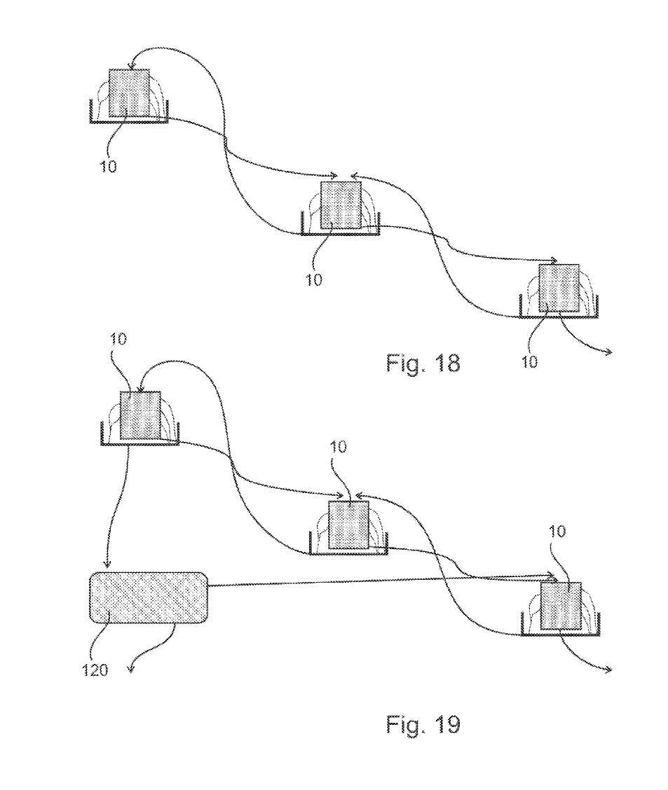

FIG. 18 is a schematic view illustrating several separation systems 10 arranged for operation in series. Each system 10 in the series performs a different degree of separation. Additionally, there is recycling of liquid (water). In the arrangement shown, liquid discarding from one system is returned to the immediately preceding system for use as replenishment water.

FIG. 19 is a view somewhat similar to the arrangement shown in FIG. 18 but with liquid (water) discharged from the first system in the series being treated by flocculation at 121 to separate the undersize solids from the liquid, with the undersize solids being discharged to a dump and the water being utilized as replenishment water for the final system in the series. The flocculation treatment to separate the undersize solids from the liquid may be performed in a separation apparatus of any appropriate form, including in particular a separation apparatus of the type disclosed in international application PCT/AU2007/000820 in the name of Z-Filter Pty. Ltd. and relating to materials handling and treatment.

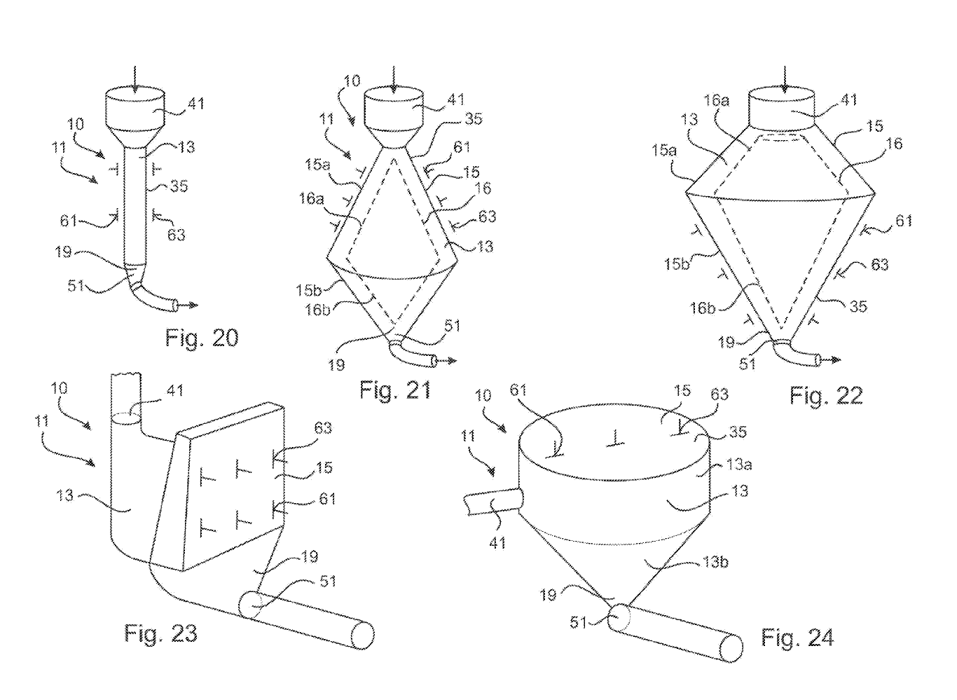

As is apparent from the example embodiments described above, the chamber 13 defined by apparatus 11 may be of various configurations. This is explained further in relation to embodiments shown in FIGS. 20 to 24, which provide additional non-limiting examples of several possible configurations. It will, however, be understood that the present invention is not limited to the configurations which are described and illustrated, and that other configurations are possible.

FIG. 20 illustrates a separation system 10 comprising apparatus 11 defining a generally cylindrical chamber 13 for receiving feed material (being slurry material comprising liquid and solid particles) under pressure. The feed material is received through delivery means 41 for delivering feed material (the slurry material) in the top end section 17 of the chamber 13. Discharge means 51 provides an outlet for removing remnant material from the bottom end section 19 of the chamber 13. In the arrangement of FIG. 20, the chamber 13 is generally cylindrical, with the cylindrical outer wall 15 of the chamber 13 being formed of flexible permeable material which defines the filtering membrane 35 providing the selective barrier through which undersize solids in the slurry, as well as liquid in the slurry, can pass but through which oversize solids cannot pass. The vibrator 61 comprising a plurality of vibration sources 63 acts upon the cylindrical outer wall 15 of the chamber 13 for selectively imparting vibration to the slurry feed material within the chamber 13, causing the filtering membrane 35 to vibrate, oscillating towards and away from the slurry within the chamber.

FIG. 21 illustrates a separation system 10 comprising apparatus 11 defining chamber 13 of annular cross-section for receiving feed material (being slurry material comprising liquid and solid particles) under pressure. In the arrangement shown, the chamber 13 is defined between outer and inners walls 15, 16 which cooperate to provide the annular configuration. The outer wall 15 includes upper and lower inclined wall sections 15a, 15b. Similarly, the inner wall 16 has counterpart upper and lower inclined wall sections 16a, 16b. In the arrangement illustrated, the upper inclined wall section 15a is formed of flexible permeable material which defines the filtering membrane 35 providing the selective barrier through which undersize solids in the slurry, as well as liquid in the slurry, can pass but through which oversize solids cannot pass. The vibrator 61 comprising a plurality of vibration sources 63 acts upon the upper inclined wall section 15a which provides the flexible permeable material.

FIG. 22 is similar to the arrangement illustrated in FIG. 21 except that the lower inclined wall section 15b is formed of the flexible permeable material which defines the filtering membrane 35 providing the selective barrier through which undersize solids in the slurry, as well as liquid in the slurry, can pass but through which oversize solids cannot pass. The vibrator 61 includes a plurality of vibration sources 63 acts upon the lower inclined wall section 15b which defines the filtering membrane 35 providing the selective barrier.

FIG. 23 illustrates a separation system 10 comprising apparatus 11 defining chamber 13 of generally cubic configuration for receiving feed material (being slurry material comprising liquid and solid particles) under pressure. In the arrangement shown, the chamber 13 has side wall 15 which is generally rectangular and upright (although other side wall configurations and dispositions are possible). The side wall 15 is formed of flexible permeable material which defines the filtering membrane 35 providing the selective barrier through which undersize solids in the slurry, as well as liquid in the slurry, can pass but through which oversize solids cannot pass. The vibrator 61 comprising a plurality of vibration sources 63 acts upon the side wall 15 which provides the flexible permeable material.

FIG. 24 illustrates a separation system 10 comprising apparatus 11 defining chamber 13 for receiving feed material (being slurry material comprising liquid and solid particles) under pressure. In the arrangement shown, the chamber 13 has an upper section 13a which is generally cylindrical and a lower section 13b which tapers downwardly to bottom 19 at which there is discharge means 51 providing an outlet for removing remnant material from the chamber 13. The cylindrical upper section 13a has a top wall 15 which is formed of flexible permeable material which defines a filtering membrane 35 providing the selective barrier through which undersize solids in the slurry, as well as liquid in the slurry, can pass but through which oversize solids cannot pass. The feed material is received through delivery means 41 for delivering feed material (the slurry material) in the cylindrical upper section 13a of the chamber 13. With this arrangement, fluid under pressure within the chamber 13 flows upwardly, with liquid and undersize solids in the slurry material passing through the barrier at the top wall 15. The vibrator 61 comprising a plurality of vibration sources 63 acts upon the top wall 15 of the chamber 13 for selectively imparting vibration to the slurry feed material within the chamber 13, causing the filtering membrane 35 to vibrate, oscillating towards and away from the slurry within the chamber.

In each of the example embodiments described and illustrated, the apparatus 11 defining the chamber 13 is a fixed structure in the sense that the outer wall 15 does not undergo movement (apart from vibration). Other arrangements are, of course, possible.

By way of example, the apparatus 11 defining the chamber 13 may be embodied as a movable structure. In one such arrangement, the chamber 13 may be defined by a tubular wall structure adapted to undergo movement. The movement may be with respect to the vibrator such that the location(s) at which a vibratory force is applied to the tubular wall structure varies with movement of the tubular structure. By way of example, the tubular wall structure may comprise a tubular structure of the type which is continuously assembled and disassembled from an endless belt in apparatus described and illustrated in aforementioned international application PCT/AU2007/000820, the contents of which are incorporated herein by way of reference. In such apparatus, there is provided an endless belt structure adapted to circulate around a path, with the endless belt structure defining one or more elongate sheets movable along the path, the one or more sheets being adapted to be releasably connected together along longitudinal edges thereof to assemble a movable tubular structure. It is within at least part of the assembled tubular structure that the chamber would be defined. The arrangement may be such that a plug constituted by a dense mass of remnant material develops within the assembled tubular structure to define the bottom of the chamber. The advancing assembled tubular structure may travel passed a vibrator operable to impose vibration to that section of the advancing tubular structure that defines the chamber. The endless belt structure may move continuously or intermittently during the separation operation.

From the foregoing, it is evident that the present embodiments each provides a separation system and method which utilize a chamber bounded by a flexible wall structure which provides a selective barrier through which some particles can pass but not others. The chamber receives slurry feed material and develops a head pressure arising from liquid contained within the chamber in response to retardation of liquid flow through the barrier. Vibration imposed on the flexible wall structure and the feed material via the liquid surface presented by the slurry feed material at the interface with the flexible wall structure facilitates passage of liquid and particles comprising undersize solids through the barrier.

The vibration also develops an environment within the chamber which separates agglomerated solids into particles which can then undergo the separation process, with undersize solids passing through the barrier and oversize solids being retained within the chamber for removal separately by other means. The vibratory motion may facilitate fracturing of agglomerated solids and “soft” solid particles within the feed material in the chamber, developing an elutriated condition within the chamber. This action is somewhat akin to the phenomenon of soil liquefaction which can be observed in certain earthquake situations, whereby repeated loadings arising from earthquake shaking (vibration) causes water pressures to build up to an extent that they exceed the contact stresses between grains of soil that maintain the grains in contact with each other. This develops into a loss of soil structure, leading to a reduction or loss in the ability to transfer shear stress and a consequent soil flow regime which is akin to a liquid flow.

It should be appreciated that the scope of the present invention is not limited to the scope of the example embodiments described. By way of example, while the embodiments were described in relation to separation of fine coal from clay, the same may have application to separation of other materials. Broadly, the example embodiments may have application to solids-fluid separation, and solids-solids separation involving separation of particles according to size represented by oversized and undersized particles.

The example embodiments having been described, it is apparent that such have many varied applications. For example, the example embodiments may be applicable but not limited to connection to various devices, structures and articles.

The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

I claim:

1. A separation system, comprising:
a chamber for receiving feed material that includes a fluid containing solid particles of various sizes,
a flexible medium bounding the chamber and adapted to provide a selective barrier through which some solid particles can pass but not others, and
a vibrator adapted to impart vibration to the flexible medium to facilitate passage of fluid and certain solid particles therethrough, the vibrator further adapted to apply vibration to one or more discrete locations on an exterior face of the flexible medium with respect to the chamber, the vibration causing the flexible medium to oscillate towards and away from fluid within the chamber.

2. The system of claim 1, wherein the vibration induces fracturing of agglomerated matter comprising the solid particles within the fluid, leading to fragmentation of the agglomerated matter into the oversize solids and the undersize solids.

3. The system of claim 1, wherein the vibration has an effect of introducing a frequency of vibration or a shock wave into the liquid surface at the interface with the flexible medium and across the flexible medium.

4. The system of claim 1, wherein the fluid exerts pressure within the chamber, the pressure being used in generation of the vibration.

5. The system of claim 1, wherein the flexible medium presents an interior face exposed to the chamber and an exterior face from which the separated fluid and particles discharge after passage through the flexible medium.

6. The system of claim 1 wherein the chamber has an outlet through which remnant material comprising the oversize solids can leave the chamber.

7. The system of claim 6, the system further adapted to cause impedance to flow of fluid from the chamber through an outlet thereof.

8. The system of claim 7, wherein said provision comprises configuration of the outlet to generate a fluid pressure head which provides the impedance to flow.

9. The system of claim 1, wherein a delivery rate of feed material into the chamber is regulated according to a rate at which remnant feed material moves continually through an outlet thereof.

10. The system of claim 1, wherein the vibrator is adapted to apply vibration to a plurality of discrete locations.

11. The system of claim 10, wherein the plurality of discrete locations include one or more discrete locations disposed at spaced intervals on the exterior face of the flexible medium.

12. The system of claim 11, wherein the discrete locations include on or more permanent locations, and the vibration is applied to the same discrete locations throughout the separation process.

13. The system of claim 12, wherein the discrete locations include one or more transitory locations, and locations on the exterior face to which vibration is applied vary during the separation process.

14. The system of claim 1, wherein the vibrator is adapted to impose a vibratory force on the flexible medium at each discrete location in one vibration direction only, relying on other forces to impose a return motion to the flexible medium at the discrete location to thereby establish oscillatory vibration motion.

15. The system of claim 14, wherein the vibrator is adapted to impose an inwardly directed force at each discrete location, and a return force to complete oscillatory motion is provided by fluid pressure exerted on the interior face of the flexible medium by fluid within the chamber.

16. The system of claim 1, wherein the flexible medium includes a filtering membrane adapted to provide a barrier to oversize solids while allowing passage of fluid and undersize particles therethrough.

17. The system of claim 1, further comprising a discharge means for removing remnant material from the chamber.

18. The system of claim 17, wherein the discharge means comprises a fluid delivery system for promoting flow of the obstructing dense mass of material.

19. The system of claim 1, further comprising means for delivery of replenishment fluid into the chamber.

20. A method of separating solid particles of various sizes into oversize and undersize solids, comprising:
forming a mixture including a fluid and solid particles,
introducing the mixture into a chamber bounded by a flexible medium adapted to provide a selective barrier through which permitted solid particles can pass but which other solid particles are stopped, and
vibrating the flexible medium to facilitate passage of fluid and permitted particles through the flexible medium, the vibration adapted for application to one or more discrete locations on an exterior face of the flexible medium with respect to the chamber, the vibration for causing the flexible medium to oscillate towards and away from fluid within the chamber.
